(19) United States
(12) Patent Application Publication
(10) Pub. No.: US 2010/0120486 A1
(43) Pub. Date: May 13, 2010

(54) GAMING SYSTEM, GAMING DEVICE AND METHOD PROVIDING SERVER BASED CONFIGURABLE GAME PRESENTATIONS

(75) Inventors: Daniel J. DeWaal, Las Vegas, NV (US); Anthony J. Baerlocher, Reno, NV (US); David H. Muir, Warnesbay (AU)

Correspondence Address: K&L Gates LLP, P.O. Box 1135, CHICAGO, IL, 60690, US

(73) Assignee: IGT, Reno, NV (US)

(21) Appl. No.: 12/267,959

(22) Filed: Nov. 10, 2008

(51) Int. Cl. G06F 17/00

(52) U.S. Cl. 463/16; 463/43; 463/25

(57) ABSTRACT

The gaming system and method disclosed herein provides a player with the opportunity to simultaneously make separate inputs for a plurality of different games. In one embodiment, the gaming system includes a first input device and a second input device which, at a first point in time, each enable a player to make separate inputs associated with a first game. At a second point in time, such as after a designated event, the first input device enables the player to make an input associated with the first game and the second input device enables the player to make an input associated with a second, different game. That is, after the designated event, the gaming system changes the functionality of the second input device to enable the player to simultaneously make separate inputs in association with the first and second games using the first and second input devices.

### COPYRIGHT NOTICE

A portion of the disclosure of this patent document contains or may contain material which is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### BACKGROUND

Gaming machines which provide players awards in primary or base games are well known. These gaming machines generally require the player to place or make a wager and use at least one of the input devices to activate the primary or base game. Traditionally, such known gaming machines enable a player to make one or more inputs associated with the primary game on the primary display through a plurality of input devices such as mechanical buttons, a touch screen or both. In many of these gaming machines, the award is based on the player obtaining a winning symbol or symbol combination and based on the amount of the wager (e.g., the higher the wager, the higher the award). Symbols or symbol combinations which are less likely to occur usually provide higher awards.

Secondary or bonus games are also known in gaming machines. The secondary or bonus games usually provide an additional award to the player. Secondary or bonus games usually do not require an additional wager by the player to be activated. Secondary or bonus games are generally activated or triggered upon an occurrence of a designated triggering symbol or triggering symbol combination in the primary or base game. For instance, a bonus symbol occurring on the payline on the third reel of a three reel slot machine may trigger the secondary bonus game. When a secondary or bonus game is triggered, the gaming machines generally indicates this to the player through one or more visual and/or audio output devices, such as the reels, lights, speakers or video screens. Part of the enjoyment and excitement of playing certain gaming machines is the occurrence of the secondary or bonus game (even before the player knows how much the bonus award will be). Traditionally, one or more input devices enable a player to make one or more inputs to initiate the secondary game. After the secondary game is initiated, known gaming machines operate the primary game and the secondary game sequentially. Thus, such known gaming machines do not provide the players at these gaming machines with an opportunity to simultaneously interact with or make inputs for both the primary game and the secondary game utilizing the input devices.

Certain known gaming machines display the primary game and any bonus or secondary games on a primary display. Other known gaming machines display the primary game on the primary display and any bonus or secondary games on a secondary display. Typically, in such known gaming machines, the primary display is associated with a touch screen. The primary display is traditionally positioned proximate the player while the player is sitting at the gaming device. That is, the primary display is generally positioned substantially at a seated player's eye level so that the touch screen is within the seated player's reach. On the other hand, the secondary display is traditionally positioned above the primary display and outside the player's reach while sitting at the gaming machine. Because the secondary display is traditionally positioned outside of the seated player's reach, the secondary displays of such known gaming devices have typically not included touch screens (to save in manufacturing costs). Known gaming machines have not provided the players at these gaming machines with an opportunity to utilize a touch screen to interact with or make inputs for a secondary game displayed on the secondary display while simultaneously providing the players with an opportunity to interact with or make inputs for a primary game displayed on a primary display.

Accordingly, there is a continuing need to provide new and different gaming machines and gaming systems as well as new and different ways to display and make inputs for games including primary games and secondary games. There is also a continuing need to provide new and different linked or related gaming machines.

### SUMMARY

The gaming system and method disclosed herein enables a player with the opportunity to make one or more inputs associated with a plurality of games simultaneously by changing the functionality of one or more input devices of the gaming system in response to an occurrence of a designated event. In one embodiment, the disclosed gaming system and method includes a first input device and a second input device which, at a first point in time, operate with a first game. After the designated event occurs, at a second point in time, the first input device operates with the first game and the second input device operates with a second, different game. That is, after the designated event, the functionality of the second input device changes such that the first input device operates with the first game and the second input device operates with the second game to enable a player to simultaneously make separate inputs for the first and second games.

In one embodiment, the disclosed gaming system and method displays a first game on a primary display device at a first point in time. In this embodiment, the first game is operable with both of a plurality of mechanical input buttons and a touch screen. That is, at the first point in time when a first game is displayed on the primary display device, the gaming system enables a player to make one or more inputs associated with the first game by either utilizing the mechanical input buttons or utilizing the touch screen. In this embodiment, after a designated input device reconfiguration event occurs at a second point in time, the gaming system displays a second game on a secondary display device. At this second point in time, the gaming system changes the functionality of the mechanical input buttons to enable a player to make one or more inputs associated with the second game. That is, at this second point in time when both the primary and secondary game are displayed, the gaming system enables a player to simultaneously make one or more inputs associated with: (i) the first game displayed on the primary display device utilizing the touch screen, (ii) the second game displayed on the secondary display device utilizing the mechanical input buttons, and (iii) vice versa. Providing separate and independent input devices for the first and second games enables the disclosed gaming system and method to provide a player with the opportunity to play and interact with the first and second games simultaneously.

In one embodiment, the disclosed gaming system and method causes the first game (e.g., a primary game) displayed on the primary display device to switch or reconfigure display locations with the second game (e.g., a primary game or a bonus game) displayed on the secondary display device. In this embodiment, at a first point in time, the disclosed gaming system and method causes the primary display device to display the first game and causes a secondary display device to display the second game. At a second point in time, such as after a designated display device reconfiguration event occurs, the disclosed gaming system and method switches or reconfigures the displayed location of the first and second games. That is, at the second point in time, the primary display device displays the second game and the secondary display device displays the first game. The gaming system enables the player to swap display locations of the first and second games so that the player can focus on a selected game (e.g., the game displayed by the first display device) while also making inputs for a non-selected game (e.g., the game displayed on the second display device).

In one embodiment, the disclosed gaming system and method redefines or reconfigures at least one of the plurality of input devices based upon which of the first or second games are currently being played by a player. For example, the first game is a poker game initially displayed on the primary display device and the second game is a selection game initially displayed on the secondary display device. In this example, the gaming system associates a first input device, such as a touch screen, with the holding or discarding of playing cards dealt to the player and associates a second input device such as a plurality of mechanical input buttons with making a selection in the selection game. That is, the gaming system enables the player to simultaneously make one or more inputs associated with the poker game utilizing the touch screen and the selection game utilizing the mechanical input buttons. In this example, if the player switches or moves the selection game to the primary display device, the gaming system changes or reconfigures the functions of the first and second input devices based on which of the first and second games is being displayed on the primary display device. That is, if the primary display device displays the selection game, the gaming system redefines or reconfigures the first input device (e.g., the touch screen) to enable the player to make a selection in the selection game displayed by the primary display device and redefines or reconfigures the second input device (e.g., the plurality of buttons) to control the holding or discarding of the dealt playing cards of the poker game displayed by the secondary display device. That is, in this embodiment, the gaming system and method enables the player to simultaneously make one or more inputs in association with the poker game and make one or more inputs in association with the selection game.

In one embodiment, the gaming device processor executes a plurality of computerized instructions to control the first game provided to a player (i.e., a “thick” client configuration). In this embodiment, the central controller or server remotely controls the second game (alone or in combination with the gaming device processor) and the gaming device is utilized to display the second game and receive one or more inputs or commands from the player (i.e., a “thin” client configuration). That is, the gaming system concurrently displays and enables the player to play the first game having a “thick” client configuration and the second game having a “thin” client configuration.

Accordingly, the disclosed gaming system and method provides a plurality of players with an opportunity to play a plurality of games simultaneously while providing such players ways to simultaneously interact or increase their involvement with such games. Moreover, the disclosed gaming system and method enables a player to simultaneously make separate inputs for a plurality of games. In one embodiment, the gaming system provides the player with the opportunity to change or reconfigure the display location for a plurality of games. In this embodiment, if the player elects to change or reconfigure the display location for two of the games (e.g., to cause the gaming system to move or swap the displayed positions of a first game and a second game), the gaming system changes or reconfigures the functionality of at least one input device associated with each of the games such that the player can seamlessly switch between the games and simultaneously make separate inputs for both games utilizing different input devices.

Additional features and advantages are described herein, and will be apparent from the following Detailed Description and the figures.

### BRIEF DESCRIPTION OF THE FIGURES

FIG. 1 is a perspective view of one embodiment of one of the gaming devices in the gaming system of the present disclosure.

FIG. 2A is a schematic block diagram of one embodiment of an electronic configuration for one of the gaming devices disclosed herein.

FIG. 2B is a schematic block diagram of one embodiment of a gaming system network configuration including a plurality of gaming devices disclosed herein.

FIG. 3 is a process flow diagram showing one possible flow sequence of one embodiment of the disclosed gaming system.

FIGS. 4A, 4B, 4C, and 4D are front plan views of one gaming device in accordance with one embodiment of the disclosed gaming system.

FIGS. 5A, 5B, 5C, and 5D are front plan views of one gaming device in accordance with one embodiment of the disclosed gaming system.

FIGS. 6A, 6B, 6C, and 6D are front plan views of one gaming device in accordance with one embodiment of the disclosed gaming system.

### DETAILED DESCRIPTION

The present disclosure may be implemented in various configurations for gaming machines, gaming devices, or gaming systems, including but not limited to: (1) a dedicated gaming machine, gaming device, or gaming systems wherein the computerized instructions for controlling any games (which are provided by the gaming machine or gaming device) are provided with the gaming machine or gaming device prior to delivery to a gaming establishment; and (2) a changeable gaming machine, gaming device, or gaming system wherein the computerized instructions for controlling any games (which are provided by the gaming machine or gaming device) are downloadable to the gaming machine or gaming device through a data network after the gaming machine or gaming device is in a gaming establishment. In one embodiment, the computerized instructions for controlling any games are executed by at least one central server, central controller, or remote host. In such a “thin client” embodiment, the central server remotely controls any games (or other suitable interfaces) and the gaming device is utilized to display such games (or suitable interfaces) and receive one or more inputs or commands from a player. In another embodiment, the computerized instructions for controlling any games are communicated from the central server, central controller, or remote host to a gaming device local processor and memory devices. In such a “thick client” embodiment, the gaming device local processor executes the communicated computerized instructions to control any games (or other suitable interfaces) provided to a player.

In one embodiment, one or more gaming devices in a gaming system may be thin client gaming devices and one or more gaming devices in the gaming system may be thick client gaming devices. In another embodiment, certain functions of the gaming device are implemented in a thin client environment and certain other functions of the gaming device are implemented in a thick client environment. In one such embodiment, computerized instructions for controlling any primary games are communicated from the central server to the gaming device in a thick client configuration and computerized instructions for controlling any secondary games or bonus functions are executed by a central server in a thin client configuration. In one embodiment, at least one gaming device in the gaming system includes a primary display device which is operable for displaying a primary game communicated from the central server to the gaming device in the thick client configuration and a secondary display device which is operable for displaying a secondary game or bonus function executed by the central server in the thin client configuration. In this embodiment, at a different point in time, such as after a designated display device reconfiguration event, the primary display device is operable for displaying the secondary game or bonus function executed by the central server in the thin client configuration and the secondary display device is operable for displaying the primary game communicated from the central server in the thick client configuration.

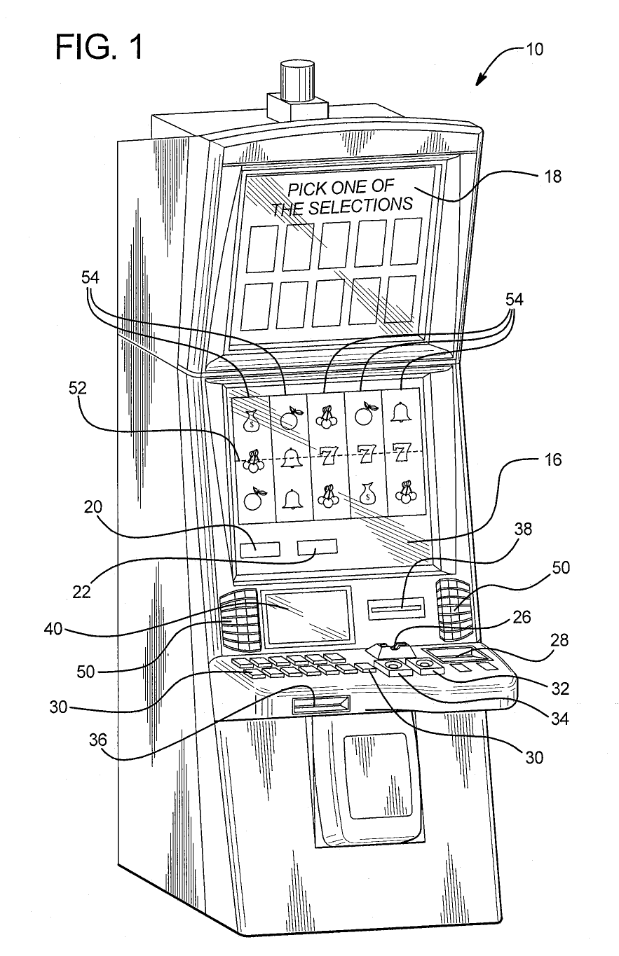

Referring now to the drawings, one example embodiment of a gaming device disclosed herein is illustrated in FIG. 1. In the embodiment illustrated in FIG. 1, gaming device 10 has a support structure, housing, or cabinet which provides support for a plurality of displays, inputs, controls, and other features of a conventional gaming machine. It is configured so that a player can operate it while standing or sitting. The gaming device can be positioned on a base or stand or can be configured as a pub-style table-top game (not shown) which a player can operate preferably while sitting. As illustrated in the embodiment illustrated in FIG. 1, the gaming device may have varying cabinet and display configurations.

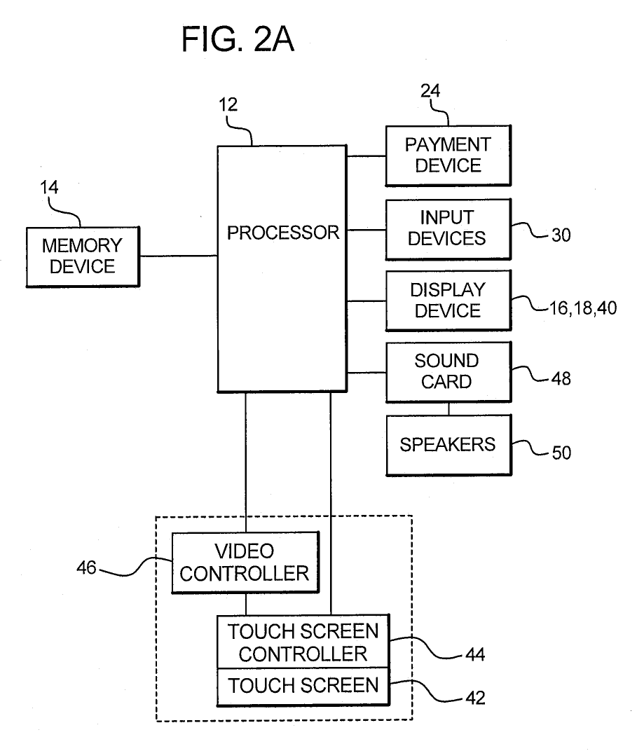

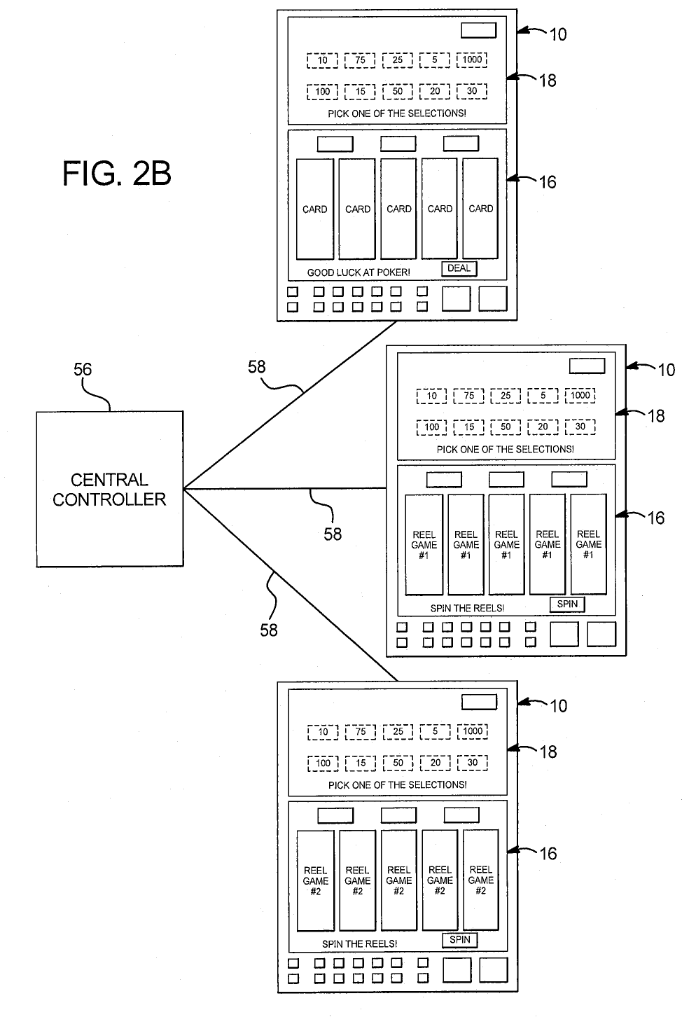

In one embodiment, as illustrated in FIG. 2A, the gaming device preferably includes at least one processor 12, such as a microprocessor, a microcontroller-based platform, a suitable integrated circuit or one or more application-specific integrated circuits (ASIC's). The processor is in communication with or operable to access or to exchange signals with at least one data storage or memory device 14. In one embodiment, the processor and the memory device reside within the cabinet of the gaming device. The memory device stores program code and instructions, executable by the processor, to control the gaming device. The memory device also stores other data such as image data, event data, player input data, random or pseudo-random number generators, pay-table data or information, and applicable game rules that relate to the play of the gaming device. In one embodiment, the memory device includes random access memory (RAM), which can include non-volatile RAM (NVRAM), magnetic RAM (MRAM), ferroelectric RAM (FeRAM), and other forms as commonly understood in the gaming industry. In one embodiment, the memory device includes read only memory (ROM). In one embodiment, the memory device includes flash memory and/or EEPROM (electrically erasable programmable read only memory). Any other suitable magnetic, optical, and/or semiconductor memory may operate in conjunction with the gaming device disclosed herein.

In one embodiment, part or all of the program code and/or operating data described above can be stored in a detachable or removable memory device, including, but not limited to, a suitable cartridge, disk, CD ROM, DVD, or USB memory device. In other embodiments, part or all of the program code and/or operating data described above can be downloaded to the memory device through a suitable network.

In one embodiment, an operator or a player can use such a removable memory device in a desktop computer, a laptop computer, a personal digital assistant (PDA), a portable computing device, or another computerized platform to implement the present disclosure. In one embodiment, the gaming device or gaming machine disclosed herein is operable over a wireless network, for example part of a wireless gaming system. In this embodiment, the gaming machine may be a hand-held device, a mobile device, or any other suitable wireless device that enables a player to play any suitable game at a variety of different locations. It should be appreciated that a gaming device or gaming machine as disclosed herein may be a device that has obtained approval from a regulatory gaming commission or a device that has not obtained approval from a regulatory gaming commission. It should be appreciated that the processor and memory device may be collectively referred to herein as a “computer” or “controller.”

In one embodiment, as discussed in more detail below, the gaming device randomly generates awards and/or other game outcomes based on probability data. In one such embodiment, this random determination is provided through utilization of a random number generator (RNG), such as a true random number generator, a pseudo random number generator, or other suitable randomization process. In one embodiment, each award or other game outcome is associated with a probability and the gaming device generates the award or other game outcome to be provided to the player based on the associated probabilities. In this embodiment, since the gaming device generates outcomes randomly or based upon one or more probability calculations, there is no certainty that the gaming device will ever provide the player with any specific award or other game outcome.

In another embodiment, as discussed in more detail below, the gaming device employs a predetermined or finite set or pool of awards or other game outcomes. In this embodiment, as each award or other game outcome is provided to the player, the gaming device flags or removes the provided award or other game outcome from the predetermined set or pool. Once flagged or removed from the set or pool, the specific provided award or other game outcome from that specific pool cannot be provided to the player again. This type of gaming device provides players with all of the available awards or other game outcomes over the course of the play cycle and guarantees the amount of actual wins and losses.

In another embodiment, as discussed below, upon a player initiating game play at the gaming device, the gaming device enrolls in a bingo game. In this embodiment, a bingo server calls the bingo balls that result in a specific bingo game outcome. The resultant game outcome is communicated to the individual gaming device to be provided to a player. In one embodiment, this bingo outcome is displayed to the player as a bingo game and/or in any form in accordance with the present disclosure.

In one embodiment, as illustrated in FIG. 2A, the gaming device includes one or more display devices controlled by the processor. The display devices are preferably connected to or mounted on the cabinet of the gaming device. The embodiment shown in FIG. 1 includes a central display device 16 which displays a primary game. This display device may also display any suitable secondary game associated with the primary game as well as information relating to the primary or secondary game. The embodiment shown in FIG. 1 also includes an upper display device 18. The upper display device may display the primary game, any suitable secondary game associated or not associated with the primary game and/or information relating to the primary or secondary game. For example, as seen in the embodiment illustrated in FIG. 1, the upper display device 18 displays a selection game including a plurality of selections associated with a plurality of awards. In one embodiment, one or both of these display devices may also serve as digital glass operable to advertise games or other aspects of the gaming establishment.

As seen in FIG. 1, in one embodiment, the gaming device includes a credit display 20 which displays a player's current number of credits, cash, account balance, or the equivalent. In one embodiment, the gaming device includes a bet display 22 which displays a player's amount wagered. In one embodiment, as described in more detail below, the gaming device includes a player tracking display 40 which displays information regarding a player's play tracking status.

In another embodiment, at least one display device may be a mobile display device, such as a PDA or tablet PC, that enables play of at least a portion of the primary or secondary game at a location remote from the gaming device.

The display devices may include, without limitation, a monitor, a television display, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. In one embodiment, as described in more detail below, the display device includes a touch-screen with an associated touch-screen controller. The display devices may be of any suitable size and configuration, such as a square, a rectangle or an elongated rectangle.

The display devices of the gaming device are configured to display at least one and preferably a plurality of game or other suitable images, symbols and indicia such as any visual representation or exhibition of the movement of objects such as mechanical, virtual, or video reels and wheels, dynamic lighting, video images, images of people, characters, places, things, faces of cards, and the like.

In one alternative embodiment, the symbols, images and indicia displayed on or of the display device may be in mechanical form. That is, the display device may include any electromechanical device, such as one or more mechanical objects, such as one or more rotatable wheels, reels, or dice, configured to display at least one or a plurality of game or other suitable images, symbols or indicia.

As illustrated in FIG. 2A, in one embodiment, the gaming device includes at least one payment device 24 in communication with the processor. As seen in FIG. 1, a payment device such as a payment acceptor includes a note, ticket or bill acceptor 28 wherein the player inserts paper money, a ticket, or voucher and a coin slot 26 where the player inserts money, coins, or tokens. In other embodiments, payment devices such as readers or validators for credit cards, debit cards or credit slips may accept payment. In one embodiment, a player may insert an identification card into a card reader of the gaming device. In one embodiment, the identification card is a smart card having a programmed microchip or a magnetic strip coded with a player's identification, credit totals (or related data), and other relevant information. In another embodiment, a player may carry a portable device, such as a cell phone, a radio frequency identification tag, or any other suitable wireless device, which communicates a player's identification, credit totals (or related data), and other relevant information to the gaming device. In one embodiment, money may be transferred to a gaming device through electronic funds transfer. When a player funds the gaming device, the processor determines the amount of funds entered and displays the corresponding amount on the credit or other suitable display as described above.

As seen in FIGS. 1 and 2A, in one embodiment the gaming device includes at least one and preferably a plurality of input devices 30 in communication with the processor. The input devices can include any suitable device which enables the player to produce an input signal which is received by the processor as further described below. In one embodiment, the player may push one of the input devices 30 and cash out to receive a cash payment or other suitable form of payment corresponding to the number of remaining credits. In one embodiment, when the player cashes out, a payment device, such as a ticket, payment, or note generator 36 prints or otherwise generates a ticket or credit slip to provide to the player. The player receives the ticket or credit slip and may redeem the value associated with the ticket or credit slip via a cashier (or other suitable redemption system). In another embodiment, when the player cashes out, the player receives the coins or tokens in a coin payout tray. It should be appreciated that any suitable payout mechanisms, such as funding to the player's electronically recordable identification card, may be implemented in accordance with the gaming device disclosed herein.

In one embodiment, as mentioned above, one input device is a touch-screen 42 coupled with a touch-screen controller 44 or some other touch-sensitive display overlay to allow for player interaction with the images on the display. In one embodiment, as seen in FIG. 2A, the touch-screen 42 and the touch-screen controller 44 are connected to a video controller 46.

The gaming device may further include a plurality of communication ports for enabling communication of the processor with external peripherals, such as external video sources, expansion buses, game or other displays, a SCSI port, or a keypad.

In one embodiment, as seen in FIG. 2A, the gaming device includes a sound generating device controlled by one or more sounds cards 48 which function in conjunction with the processor. In one embodiment, the sound generating device includes at least one and preferably a plurality of speakers 50 or other sound generating hardware and/or software for generating sounds, such as by playing music for the primary and/or secondary game or by playing music for other modes of the gaming device, such as an attract mode. In one embodiment, the gaming device provides dynamic sounds coupled with attractive multimedia images displayed on one or more of the display devices to provide an audio-visual representation or to otherwise display full-motion video with sound to attract players to the gaming device. During idle periods, the gaming device may display a sequence of audio and/or visual attraction messages to attract potential players to the gaming device. The videos may also be customized to provide any appropriate information.

In one embodiment, the gaming machine may include a sensor, such as a camera in communication with the processor (and possibly controlled by the processor), that is selectively positioned to acquire an image of a player actively using the gaming device and/or the surrounding area of the gaming device. In one embodiment, the camera may be configured to selectively acquire still or moving (e.g., video) images and may be configured to acquire the images in an analog, digital, or other suitable format. The display devices may be configured to display the image acquired by the camera as well as to display the visible manifestation of the game in split screen or picture-in-picture fashion. For example, the camera may acquire an image of the player and the processor may incorporate that image into the primary and/or secondary game as a game image, symbol or indicia.

Gaming device 10 can incorporate any suitable wagering game as the primary or base game. The gaming machine or device may include some or all of the features of conventional gaming machines or devices. The primary or base game may comprise any suitable reel-type game, card game, cascading or falling symbol game, number game, or other game of chance susceptible to representation in an electronic or electromechanical form, which in one embodiment produces a random outcome based on probability data at the time of or after placement of a wager. That is, different primary wagering games, such as video poker games, video blackjack games, video keno, video bingo or any other suitable primary or base game may be implemented.

In one embodiment, as illustrated in FIG. 1, a base or primary game may be a slot game with one or more paylines 52. The paylines may be horizontal, vertical, circular, diagonal, angled or any combination thereof. In this embodiment, the gaming device includes at least one and preferably a plurality of reels 54, such as three to five reels 54, in either electromechanical form with mechanical rotating reels or video form with simulated reels and movement thereof. In one embodiment, an electromechanical slot machine includes a plurality of adjacent, rotatable reels which may be combined and operably coupled with an electronic display of any suitable type. In another embodiment, if the reels 54 are in video form, one or more of the display devices, as described above, displays the plurality of simulated video reels 54. Each reel 54 displays a plurality of indicia or symbols, such as bells, hearts, fruits, numbers, letters, bars, or other images which preferably correspond to a theme associated with the gaming device. In another embodiment, one or more of the reels are independent reels or unisymbol reels. In this embodiment, each independent or unisymbol reel generates and displays one symbol to the player. In one embodiment, the gaming device awards prizes after the reels of the primary game stop spinning if specified types and/or configurations of indicia or symbols occur on an active payline or otherwise occur in a winning pattern, occur on the requisite number of adjacent reels and/or occur in a scatter pay arrangement.

In an alternative embodiment, rather than determining any outcome to provide to the player by analyzing the symbols generated on any wagered upon paylines as described above, the gaming device determines any outcome to provide to the player based on the number of associated symbols which are generated in active symbol positions on the requisite number of adjacent reels (i.e., not on paylines passing through any displayed winning symbol combinations). In this embodiment, if a winning symbol combination is generated on the reels, the gaming device provides the player one award for that occurrence of the generated winning symbol combination. For example, if one winning symbol combination is generated on the reels, the gaming device will provide a single award to the player for that winning symbol combination (i.e., not based on the number of paylines that would have passed through that winning symbol combination). It should be appreciated that because a gaming device that enables wagering on ways to win provides the player one award for a single occurrence of a winning symbol combination and a gaming device with paylines may provide the player more than one award for the same occurrence of a single winning symbol combination (i.e., if a plurality of paylines each pass through the same winning symbol combination), it is possible to provide a player at a ways to win gaming device with more ways to win for an equivalent bet or wager on a traditional slot gaming device with paylines.

In one embodiment, the total number of ways to win is determined by multiplying the number of symbols generated in active symbol positions on a first reel by the number of symbols generated in active symbol positions on a second reel by the number of symbols generated in active symbol positions on a third reel and so on for each reel of the gaming device with at least one symbol generated in an active symbol position. For example, a three reel gaming device with three symbols generated in active symbol positions on each reel includes 27 ways to win (i.e., 3 symbols on the first reel×3 symbols on the second reel×3 symbols on the third reel). A four reel gaming device with three symbols generated in active symbol positions on each reel includes 81 ways to win (i.e., 3 symbols on the first reel×3 symbols on the second reel×3 symbols on the third reel×3 symbols on the fourth reel). A five reel gaming device with three symbols generated in active symbol positions on each reel includes 243 ways to win (i.e., 3 symbols on the first reel×3 symbols on the second reel×3 symbols on the third reel×3 symbols on the fourth reel×3 symbols on the fifth reel). It should be appreciated that modifying the number of generated symbols by either modifying the number of reels or modifying the number of symbols generated in active symbol positions by one or more of the reels modifies the number of ways to win.

In another embodiment, the gaming device enables a player to wager on and thus activate symbol positions. In one such embodiment, the symbol positions are on the reels. In this embodiment, if based on the player's wager, a reel is activated, then each of the symbol positions of that reel will be activated and each of the active symbol positions will be part of one or more of the ways to win. In one embodiment, if based on the player's wager, a reel is not activated, then a designated number of default symbol positions, such as a single symbol position of the middle row of the reel, will be activated and the default symbol position(s) will be part of one or more of the ways to win. This type of gaming machine enables a player to wager on one, more than one or all of the reels and the processor of the gaming device uses the number of wagered on reels to determine the active symbol positions and the number of possible ways to win. In alternative embodiments, (1) no symbols are displayed as generated at any of the inactive symbol positions, or (2) any symbols generated at any inactive symbol positions may be displayed to the player but suitably shaded or otherwise designated as inactive.

In one embodiment wherein a player wagers on one or more reels, a player's wager of one credit may activate each of the three symbol positions on a first reel, wherein one default symbol position is activated on each of the remaining four reels. In this example, as described above, the gaming device provides the player three ways to win (i.e., 3 symbols on the first reel×1 symbol on the second reel×1 symbol on the third reel×1 symbol on the fourth reel×1 symbol on the fifth reel). In another example, a player's wager of nine credits may activate each of the three symbol positions on a first reel, each of the three symbol positions on a second reel and each of the three symbol positions on a third reel wherein one default symbol position is activated on each of the remaining two reels. In this example, as described above, the gaming device provides the player twenty-seven ways to win (i.e., 3 symbols on the first reel×3 symbols on the second reel×3 symbols on the third reel×1 symbol on the fourth reel×1 symbol on the fifth reel).

In one embodiment, to determine any award(s) to provide to the player based on the generated symbols, the gaming device individually determines if a symbol generated in an active symbol position on a first reel forms part of a winning symbol combination with or is otherwise suitably related to a symbol generated in an active symbol position on a second reel. In this embodiment, the gaming device classifies each pair of symbols which form part of a winning symbol combination (i.e., each pair of related symbols) as a string of related symbols. For example, if active symbol positions include a first cherry symbol generated in the top row of a first reel and a second cherry symbol generated in the bottom row of a second reel, the gaming device classifies the two cherry symbols as a string of related symbols because the two cherry symbols form part of a winning symbol combination.

After determining if any strings of related symbols are formed between the symbols on the first reel and the symbols on the second reel, the gaming device determines if any of the symbols from the next adjacent reel should be added to any of the formed strings of related symbols. In this embodiment, for a first of the classified strings of related symbols, the gaming device determines if any of the symbols generated by the next adjacent reel form part of a winning symbol combination or are otherwise related to the symbols of the first string of related symbols. If the gaming device determines that a symbol generated on the next adjacent reel is related to the symbols of the first string of related symbols, that symbol is subsequently added to the first string of related symbols. For example, if the first string of related symbols is the string of related cherry symbols and a related cherry symbol is generated in the middle row of the third reel, the gaming device adds the related cherry symbol generated on the third reel to the previously classified string of cherry symbols.

On the other hand, if the gaming device determines that no symbols generated on the next adjacent reel are related to the symbols of the first string of related symbols, the gaming device marks or flags such string of related symbols as complete. For example, if the first string of related symbols is the string of related cherry symbols and none of the symbols of the third reel are related to the cherry symbols of the previously classified string of cherry symbols, the gaming device marks or flags the string of two cherry symbols as complete.

After either adding a related symbol to the first string of related symbols or marking the first string of related symbols as complete, the gaming device proceeds as described above for each of the remaining classified strings of related symbols which were previously classified or formed from related symbols on the first and second reels.

After analyzing each of the remaining strings of related symbols, the gaming device determines, for each remaining pending or incomplete string of related symbols, if any of the symbols from the next adjacent reel, if any, should be added to any of the previously classified strings of related symbols. This process continues until either each string of related symbols is complete or there are no more adjacent reels of symbols to analyze. In this embodiment, where there are no more adjacent reels of symbols to analyze, the gaming device marks each of the remaining pending strings of related symbols as complete.

When each of the strings of related symbols is marked complete, the gaming device compares each of the strings of related symbols to an appropriate paytable and provides the player any award associated with each of the completed strings of symbols. It should be appreciated that the player is provided one award, if any, for each string of related symbols generated in active symbol positions (i.e., as opposed to a quantity of awards being based on how many paylines that would have passed through each of the strings of related symbols in active symbol positions).

In one embodiment, a base or primary game may be a poker game wherein the gaming device enables the player to play a conventional game of video draw poker and initially deals five cards all face up from a virtual deck of fifty-two cards. Cards may be dealt as in a traditional game of cards or in the case of the gaming device, the cards may be randomly selected from a predetermined number of cards. If the player wishes to draw, the player selects the cards to hold via one or more input devices, such as by pressing related hold buttons or via the touch screen. The player then presses the deal button and the unwanted or discarded cards are removed from the display and the gaming machine deals the replacement cards from the remaining cards in the deck. This results in a final five-card hand. The gaming device compares the final five-card hand to a payout table which utilizes conventional poker hand rankings to determine the winning hands. The gaming device provides the player with an award based on a winning hand and the number of credits the player wagered.

In another embodiment, the base or primary game may be a multi-hand version of video poker. In this embodiment, the gaming device deals the player at least two hands of cards. In one such embodiment, the cards are the same cards. In one embodiment each hand of cards is associated with its own deck of cards. The player chooses the cards to hold in a primary hand. The held cards in the primary hand are also held in the other hands of cards. The remaining non-held cards are removed from each hand displayed and for each hand replacement cards are randomly dealt into that hand. Since the replacement cards are randomly dealt independently for each hand, the replacement cards for each hand will usually be different. The poker hand rankings are then determined hand by hand against a payout table and awards are provided to the player.

In one embodiment, a base or primary game may be a keno game wherein the gaming device displays a plurality of selectable indicia or numbers on at least one of the display devices. In this embodiment, the player selects at least one bit potentially a plurality of the selectable indicia or numbers via an input device such as a touch screen. The gaming device then displays a series of drawn numbers and determine an amount of matches, if any, between the player's selected numbers and the gaming device's drawn numbers. The player is provided an award based on the amount of matches, if any, based on the amount of determined matches and the number of numbers drawn.

In one embodiment, in addition to winning credits or other awards in a base or primary game, the gaming device may also give players the opportunity to win credits in a bonus or secondary game or in a bonus or secondary round. The bonus or secondary game enables the player to obtain a prize or payout in addition to the prize or payout, if any, obtained from the base or primary game. In general, a bonus or secondary game produces a significantly higher level of player excitement than the base or primary game because it provides a greater expectation of winning than the base or primary game, and is accompanied with more attractive or unusual features than the base or primary game. In one embodiment, the bonus or secondary game may be any type of suitable game, either similar to or completely different from the base or primary game.

In one embodiment, the triggering event or qualifying condition may be a selected outcome in the primary game or a particular arrangement of one or more indicia on a display device in the primary game, such as the number seven appearing on three adjacent reels along a payline in the primary slot game embodiment seen in FIG. 1. In other embodiments, the triggering event or qualifying condition occurs based on exceeding a certain amount of game play (such as number of games, number of credits, amount of time), or reaching a specified number of points earned during game play.

In another embodiment, the gaming device processor 12 or central server 56 randomly provides the player one or more plays of one or more secondary games. In one such embodiment, the gaming device does not provide any apparent reason to the player for qualifying to play a secondary or bonus game. In this embodiment, qualifying for a bonus game is not triggered by an event in or based specifically on any of the plays of any primary game. That is, the gaming device may simply qualify a player to play a secondary game without any explanation or alternatively with simple explanations. In another embodiment, the gaming device (or central server) qualifies a player for a secondary game at least partially based on a game triggered or symbol triggered event, such as at least partially based on the play of a primary game.

In one embodiment, the gaming device includes a program which will automatically begin a bonus round after the player has achieved a triggering event or qualifying condition in the base or primary game. In another embodiment, after a player has qualified for a bonus game, the player may subsequently enhance his/her bonus game participation through continued play on the base or primary game. Thus, for each bonus qualifying event, such as a bonus symbol, that the player obtains, a given number of bonus game wagering points or credits may be accumulated in a “bonus meter” programmed to accrue the bonus wagering credits or entries toward eventual participation in a bonus game. The occurrence of multiple such bonus qualifying events in the primary game may result in an arithmetic or exponential increase in the number of bonus wagering credits awarded. In one embodiment, the player may redeem extra bonus wagering credits during the bonus game to extend play of the bonus game.

In one embodiment, no separate entry fee or buy-in for a bonus game is needed. That is, a player may not purchase entry into a bonus game; rather they must win or earn entry through play of the primary game, thus encouraging play of the primary game. In another embodiment, qualification of the bonus or secondary game is accomplished through a simple “buy-in” by the player—for example, if the player has been unsuccessful at qualifying through other specified activities. In another embodiment, the player must make a separate side-wager on the bonus game or wager a designated amount in the primary game to qualify for the secondary game. In this embodiment, the secondary game triggering event must occur and the side-wager (or designated primary game wager amount) must have been placed to trigger the secondary game.

In one embodiment, as illustrated in FIG. 2B, one or more of the gaming devices 10 are in communication with each other and/or at least one central server, central controller or remote host 56 through a data network or remote communication link 58. In this embodiment, the central server, central controller or remote host is any suitable server or computing device which includes at least one processor and at least one memory or storage device. In different such embodiments, the central server is a progressive controller or a processor of one of the gaming devices in the gaming system. In these embodiments, the processor of each gaming device is designed to transmit and receive events, messages, commands, or any other suitable data or signal between the individual gaming device and the central server. The gaming device processor is operable to execute such communicated events, messages, or commands in conjunction with the operation of the gaming device. Moreover, the processor of the central server is designed to transmit and receive events, messages, commands, or any other suitable data or signal between the central server and each of the individual gaming devices. The central server processor is operable to execute such communicated events, messages, or commands in conjunction with the operation of the central server. It should be appreciated that one, more or each of the functions of the central controller as disclosed herein may be performed by one or more gaming device processors. It should be further appreciated that one, more or each of the functions of one or more gaming device processors as disclosed herein may be performed by the central controller.

In one embodiment, the game outcome provided to the player is determined by a central server or controller and provided to the player at the gaming device. In this embodiment, each of a plurality of such gaming devices are in communication with the central server or controller. Upon a player initiating game play at one of the gaming devices, the initiated gaming device communicates a game outcome request to the central server or controller. For example, as illustrated in FIG. 2B, a plurality of gaming devices 10 are in communication with each other and/or the at least one central server or central controller 56. Each of the gaming devices 10 display different primary games on the central display device 16 and display the same bonus or secondary game on the upper display device 18. In one such embodiment, the primary games involve a thick client configuration and the bonus or secondary games involve a thin client configuration. In one embodiment, the central display devices 16 of the gaming devices 10 display different primary games involving either a thick client configuration or a thin client configuration and the upper display devices 18 of the gaming devices 10 serve as digital glass operable to advertise games or other aspects of the gaming establishment communicated to the gaming devices 10 by the at least one central server or central controller 56.

In one embodiment, the central server or controller receives the game outcome request and randomly generates a game outcome for the primary game based on probability data. In another embodiment, the central server or controller randomly generates a game outcome for the secondary game based on probability data. In another embodiment, the central server or controller randomly generates a game outcome for both the primary game and the secondary game based on probability data. In this embodiment, the central server or controller is capable of storing and utilizing program code or other data similar to the processor and memory device of the gaming device.

In an alternative embodiment, the central server or controller maintains one or more predetermined pools or sets of predetermined game outcomes. In this embodiment, the central server or controller receives the game outcome request and independently selects a predetermined game outcome from a set or pool of game outcomes. The central server or controller flags or marks the selected game outcome as used. Once a game outcome is flagged as used, it is prevented from further selection from the set or pool and cannot be selected by the central controller or server upon another wager. The provided game outcome can include a primary game outcome, a secondary game outcome, primary and secondary game outcomes, or a series of game outcomes such as free games.

The central server or controller communicates the generated or selected game outcome to the initiated gaming device. The gaming device receives the generated or selected game outcome and provides the game outcome to the player. In an alternative embodiment, how the generated or selected game outcome is to be presented or displayed to the player, such as a reel symbol combination of a slot machine or a hand of cards dealt in a card game, is also determined by the central server or controller and communicated to the initiated gaming device to be presented or displayed to the player. Central production or control can assist a gaming establishment or other entity in maintaining appropriate records, controlling gaming, reducing and preventing cheating or electronic or other errors, reducing or eliminating win-loss volatility, and the like.

In another embodiment, a predetermined game outcome value is determined for each of a plurality of linked or networked gaming devices based on the results of a bingo, keno, or lottery game. In this embodiment, each individual gaming device utilizes one or more bingo, keno, or lottery games to determine the predetermined game outcome value provided to the player for the interactive game played at that gaming device. In one embodiment, the bingo, keno, or lottery game is displayed to the player. In another embodiment, the bingo, keno, or lottery game is not displayed to the player, but the results of the bingo, keno, or lottery game determine the predetermined game outcome value for the primary or secondary game.

In the various bingo embodiments, as each gaming device is enrolled in the bingo game, such as upon an appropriate wager or engaging an input device, the enrolled gaming device is provided or associated with a different bingo card. Each bingo card consists of a matrix or array of elements, wherein each element is designated with a separate indicia, such as a number. It should be appreciated that each different bingo card includes a different combination of elements. For example, if four bingo cards are provided to four enrolled gaming devices, the same element may be present on all four of the bingo cards while another element may solely be present on one of the bingo cards.

In operation of these embodiments, upon providing or associating a different bingo card with each of a plurality of enrolled gaming devices, the central controller randomly selects or draws, one at a time, a plurality of the elements. As each element is selected, a determination is made for each gaming device as to whether the selected element is present on the bingo card provided to that enrolled gaming device. This determination can be made by the central controller, the gaming device, a combination of the two, or in any other suitable manner. If the selected element is present on the bingo card provided to that enrolled gaming device, that selected element on the provided bingo card is marked or flagged. This process of selecting elements and marking any selected elements on the provided bingo cards continues until one or more predetermined patterns are marked on one or more of the provided bingo cards. It should be appreciated that in one embodiment, the gaming device requires the player to engage a daub button (not shown) to initiate the process of the gaming device marking or flagging any selected elements.

After one or more predetermined patterns are marked on one or more of the provided bingo cards, a game outcome is determined for each of the enrolled gaming devices based, at least in part, on the selected elements on the provided bingo cards. As described above, the game outcome determined for each gaming device enrolled in the bingo game is utilized by that gaming device to determine the predetermined game outcome provided to the player. For example, a first gaming device to have selected elements marked in a predetermined pattern is provided a first outcome of win $10 which will be provided to a first player regardless of how the first player plays in a first game, and a second gaming device to have selected elements marked in a different predetermined pattern is provided a second outcome of win $2 which will be provided to a second player regardless of how the second player plays a second game. It should be appreciated that as the process of marking selected elements continues until one or more predetermined patterns are marked, this embodiment ensures that at least one bingo card will win the bingo game and thus at least one enrolled gaming device will provide a predetermined winning game outcome to a player. It should be appreciated that other suitable methods for selecting or determining one or more predetermined game outcomes may be employed.

In one example of the above-described embodiment, the predetermined game outcome may be based on a supplemental award in addition to any award provided for winning the bingo game as described above. In this embodiment, if one or more elements are marked in supplemental patterns within a designated number of drawn elements, a supplemental or intermittent award or value associated with the marked supplemental pattern is provided to the player as part of the predetermined game outcome. For example, if the four corners of a bingo card are marked within the first twenty selected elements, a supplemental award of $10 is provided to the player as part of the predetermined game outcome. It should be appreciated that in this embodiment, the player of a gaming device may be provided a supplemental or intermittent award regardless of whether the enrolled gaming device's provided bingo card wins or does not win the bingo game as described above.

In another embodiment, one or more of the gaming devices are in communication with a central server or controller for monitoring purposes only. That is, each individual gaming device randomly generates the game outcomes to be provided to the player and the central server or controller monitors the activities and events occurring on the plurality of gaming devices. In one embodiment, the gaming network includes a real-time or on-line accounting and gaming information system operably coupled to the central server or controller. The accounting and gaming information system of this embodiment includes a player database for storing player profiles, a player tracking module for tracking players and a credit system for providing automated casino transactions.

In one embodiment, the gaming device disclosed herein is associated with or otherwise integrated with one or more player tracking systems. Player tracking systems enable gaming establishments to recognize the value of customer loyalty through identifying frequent customers and rewarding them for their patronage. In one embodiment, the gaming device and/or player tracking system tracks any player's gaming activity at the gaming device. In one such embodiment, the gaming device includes at least one card reader 38 in communication with the processor. In this embodiment, a player is issued a player identification card which has an encoded player identification number that uniquely identifies the player. When a player inserts their playing tracking card into the card reader to begin a gaming session, the card reader reads the player identification number off the player tracking card to identify the player. The gaming device and/or associated player tracking system timely tracks any suitable information or data relating to the identified player's gaming session. Directly or via the central controller, the gaming device processor communicates such information to the player tracking system, The gaming device and/or associated player tracking system also timely tracks when a player removes their player tracking card when concluding play for that gaming session. In another embodiment, rather than requiring a player to insert a player tracking card, the gaming device utilizes one or more portable devices carried by a player, such as a cell phone, a radio frequency identification tag or any other suitable wireless device to track when a player begins and ends a gaming session. In another embodiment, the gaming device utilizes any suitable biometric technology or ticket technology to track when a player begins and ends a gaming session.

During one or more gaming sessions, the gaming device and/or player tracking system tracks any suitable information or data, such as any amounts wagered, average wager amounts, and/or the time at which these wagers are placed. In different embodiments, for one or more players, the player tracking system includes the player's account number, the player's card number, the player's first name, the player's surname, the player's preferred name, the player's player tracking ranking, any promotion status associated with the player's player tracking card, the player's address, the player's birthday, the player's anniversary, the player's recent gaming sessions, or any other suitable data. In one embodiment, such tracked information and/or any suitable feature associated with the player tracking system is displayed on a player tracking display 40. In another embodiment, such tracked information and/or any suitable feature associated with the player tracking system is displayed via one or more service windows (not shown) which are displayed on the central display device and/or the upper display device.

In one embodiment, a plurality of the gaming devices are capable of being connected together through a data network. In one embodiment, the data network is a local area network (LAN), in which one or more of the gaming devices are substantially proximate to each other and an on-site central server or controller as in, for example, a gaming establishment or a portion of a gaming establishment. In another embodiment, the data network is a wide area network (WAN) in which one or more of the gaming devices are in communication with at least one off-site central server or controller. In this embodiment, the plurality of gaming devices may be located in a different part of the gaming establishment or within a different gaming establishment than the off-site central server or controller. Thus, the WAN may include an off-site central server or controller and an off-site gaming device located within gaming establishments in the same geographic area, such as a city or state. The WAN gaming system may be substantially identical to the LAN gaming system described above, although the number of gaming devices in each system may vary relative to one another.

In another embodiment, the data network is an internet or intranet. In this embodiment, the operation of the gaming device can be viewed at the gaming device with at least one internet browser. In this embodiment, operation of the gaming device and accumulation of credits may be accomplished with only a connection to the central server or controller (the internet/intranet server) through a conventional phone or other data transmission line, digital subscriber line (DSL), T-1 line, coaxial cable, fiber optic cable, or other suitable connection. In this embodiment, players may access an internet game page from any location where an internet connection and computer or other internet facilitator is available. The expansion in the number of computers and number and speed of internet connections in recent years increases opportunities for players to play from an ever-increasing number of remote sites. It should be appreciated that the enhanced bandwidth of digital wireless communications may render such technology suitable for some or all communications, particularly if such communications are encrypted. Higher data transmission speeds may be useful for enhancing the sophistication and response of the display and interaction with the player.

As mentioned above, in one embodiment, the present disclosure may be employed in a server-based gaming system. In one such embodiment, as described above, one or more gaming devices are in communication with a central server or controller. The central server or controller may be any suitable server or computing device which includes at least one processor and a memory or storage device. In alternative embodiments, the central server is a progressive controller or another gaming machine in the gaming system. In one embodiment, the memory device of the central server stores different game programs and instructions, executable by a gaming device processor, to control the gaming device. Each executable game program represents a different game or type of game which may be played on one or more of the gaming devices in the gaming system. Such different games may include the same or substantially the same game play with different pay tables, different wager denominations or different themes. In different embodiments, the executable game program is for a primary game, a secondary game or both. In another embodiment, the game program may be executable as a secondary game to be played simultaneous with the play of a primary game (which may be downloaded to or fixed on the gaming device) or vice versa.

In this embodiment, each gaming device at least includes one or more display devices and/or one or more input devices for interaction with a player. A local processor, such as the above-described gaming device processor or a processor of a local server, is operable with the display device(s) and/or the input device(s) of one or more of the gaming devices.

In operation, the central controller is operable to communicate one or more of the stored game programs to at least one local processor. In different embodiments, the stored game programs are communicated or delivered by embedding the communicated game program in a device or a component (e.g., a microchip to be inserted in a gaming device), writing the game program on a disc or other media, or downloading or streaming the game program over a dedicated data network, internet, or a telephone line. After the stored game programs are communicated from the central server, the local processor executes the communicated program to facilitate play of the communicated program by a player through the display device(s) and/or input device(s) of the gaming device. That is, when a game program is communicated to a local processor, the local processor changes the game or type of game played at the gaming device.

In another embodiment, a plurality of gaming devices at one or more gaming sites may be networked to the central server in a progressive configuration, as known in the art, wherein a portion of each wager to initiate a base or primary game may be allocated to one or more progressive awards. In one embodiment, a progressive gaming system host site computer is coupled to a plurality of the central servers at a variety of mutually remote gaming sites for providing a multi-site linked progressive automated gaming system. In one embodiment, a progressive gaming system host site computer may serve gaming devices distributed throughout a number of properties at different geographical locations including, for example, different locations within a city or different cities within a state.

In one embodiment, the progressive gaming system host site computer is maintained for the overall operation and control of the progressive gaming system. In this embodiment, a progressive gaming system host site computer oversees the entire progressive gaming system and is the master for computing all progressive jackpots. All participating gaming sites report to, and receive information from, the progressive gaming system host site computer. Each central server computer is responsible for all data communication between the gaming device hardware and software and the progressive gaming system host site computer. In one embodiment, an individual gaming machine may trigger a progressive award win. In another embodiment, a central server (or the progressive gaming system host site computer) determines when a progressive award win is triggered. In another embodiment, an individual gaming machine and a central controller (or progressive gaming system host site computer) work in conjunction with each other to determine when a progressive win is triggered, for example through an individual gaming machine meeting a predetermined requirement established by the central controller.

In one embodiment, a progressive award win is triggered based on one or more game play events, such as a symbol-driven trigger. In other embodiments, the progressive award triggering event or qualifying condition may be achieved by exceeding a certain amount of game play (such as number of games, number of credits, or amount of time), or reaching a specified number of points earned during game play. In another embodiment, a gaming device is randomly or apparently randomly selected to provide a player of that gaming device one or more progressive awards. In one such embodiment, the gaming device does not provide any apparent reasons to the player for winning a progressive award, wherein winning the progressive award is not triggered by an event in or based specifically on any of the plays of any primary game. That is, a player is provided a progressive award without any explanation or alternatively with simple explanations. In another embodiment, a player is provided a progressive award at least partially based on a game triggered or symbol triggered event, such as at least partially based on the play of a primary game.

In one embodiment, one or more of the progressive awards are each funded via a side bet or side wager. In this embodiment, a player must place or wager a side bet to be eligible to win the progressive award associated with the side bet. In one embodiment, the player must place the maximum bet and the side bet to be eligible to win one of the progressive awards. In another embodiment, if the player places or wagers the required side bet, the player may wager at any credit amount during the primary game (i.e., the player need not place the maximum bet and the side bet to be eligible to win one of the progressive awards). In one such embodiment, the greater the player's wager (in addition to the placed side bet), the greater the odds or probability that the player will win one of the progressive awards. It should be appreciated that one or more of the progressive awards may each be funded, at least in part, based on the wagers placed on the primary games of the gaming machines in the gaming system, via a gaming establishment or via any suitable manner.

In another embodiment, one or more of the progressive awards are partially funded via a side-bet or side-wager which the player may make (and which may be tracked via a side-bet meter). In one embodiment, one or more of the progressive awards are funded with only side-bets or side-wagers placed. In another embodiment, one or more of the progressive awards are funded based on player's wagers as described above as well as any side-bets or side-wagers placed.

In one alternative embodiment, a minimum wager level is required for a gaming device to qualify to be selected to obtain one of the progressive awards. In one embodiment, this minimum wager level is the maximum wager level for the primary game in the gaming machine. In another embodiment, no minimum wager level is required for a gaming machine to qualify to be selected to obtain one of the progressive awards.

In another embodiment, a plurality of players at a plurality of linked gaming devices in a gaming system participate in a group gaming environment. In one embodiment, a plurality of players at a plurality of linked gaming devices work in conjunction with one another, such as by playing together as a team or group, to win one or more awards. In one such embodiment, any award won by the group is shared, either equally or based on any suitable criteria, amongst the different players of the group. In another embodiment, a plurality of players at a plurality of linked gaming devices compete against one another for one or more awards. In one such embodiment, a plurality of players at a plurality of linked gaming devices participate in a gaming tournament for one or more awards. In another embodiment, a plurality of players at a plurality of linked gaming devices play for one or more awards wherein an outcome generated by one gaming device affects the outcomes generated by one or more linked gaming devices.

### Server Based Configurable Game Presentations

In one embodiment, the gaming system and method disclosed herein provides a plurality of configurable game presentations to a player playing at one of the gaming machines in the gaming system. In one embodiment, the gaming system and method changes or reconfigures the function of at least one input device based on the provided game presentation. In one such embodiment, the gaming system displays a plurality of different games on a plurality of different display devices. At a first point in time, the gaming system enables a player to utilize each of a first input device and a second input device to make one or more separate inputs associated with a first one of the displayed games. At a second point time, the gaming system enables the player to simultaneously utilize the first input device to make one or more inputs associated with the first displayed game and utilize the second input device to make one or more inputs associated with a second one of the displayed games. That is, at the second point in time, the player can simultaneously make separate inputs in association with the first displayed game and the second displayed game.

In one embodiment, the gaming system changes or reconfigures the function of at least one input device depending upon the game or games being currently interacted with by the player. In another embodiment, the gaming system changes or reconfigures the function of at least one input device depending upon the type of game or games being currently interacted with by the player, such as whether the game or games involve a thick client configuration or a thin client configuration. In another embodiment, the gaming system changes or reconfigures the function of at least one input device depending upon the display location, such as whether the game or games are currently being displayed by a primary display (e.g., the central display device 16) or a secondary display (e.g., the upper display device 18).

In one embodiment, the gaming system changes the function of at least one input device for a designated period. In one such embodiment, the gaming system changes the function of at least one input device for a designated amount of time. In another such embodiment, the gaming system changes the function of at least one input device for a designated number of plays of the first game (e.g., the game displayed by the primary display device) and/or a designated number of plays of the second game (e.g., the game displayed by the secondary display device).

In one embodiment, the gaming system displays a first one of the games on a first display device and associates at least one first input device with the first game displayed on the first display device. For example, at a first point in time, the gaming system causes a plurality of input devices (e.g., a touch screen and at least one mechanical input button) to function with the first game. In this embodiment, if a designated input device reconfiguration event occurs, the gaming system displays a second game on a second display device, associates one of the input devices with the second game displayed on the second display device and associates another one of the input devices with the first game displayed on the first display device. That is, the gaming system changes the functionality of at least one of the input devices such that the changed input device performs a designated function for a different game. For example, at a second point in time, the gaming system changes the functionality of at least one of the input devices (e.g., a touch screen or at least one mechanical input button) to cause that at least one input device to function with the second game and maintains the functionality of at least one other of the input devices to cause that other input device (e.g., the touch screen or at least one input button) to function with the first game. That is, at the second point in time, the gaming system reconfigures or changes the functionality of at least one of the input devices such that at least two different input devices to enable the player to make separate inputs in association with the first and second games simultaneously.

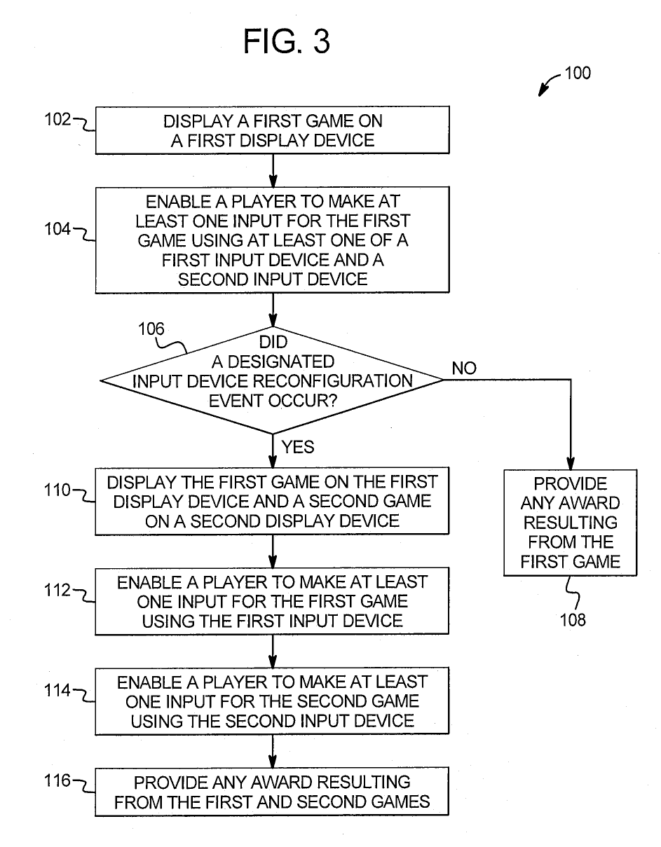

Referring now to FIG. 3, a flowchart of an example process 100 for operating a gaming system or a gaming device having a plurality of input devices with associated functions that interact with a plurality of display devices or games is illustrated. In one embodiment, the process 100 is embodied in one or more software programs stored in one or more memories and executed by one or more processors or controllers. Although the process 100 is described with reference to the flowchart illustrated in FIG. 3, it should be appreciated that many other methods of performing the acts associated with process 100 may be used. For example, the order of certain of the blocks described may be changed, or certain of the blocks described may be optional.

In operation of one embodiment, one of the gaming machines in the gaming system displays a first game, such as a primary game, on a first display device as indicated in block 102. In one such embodiment, the first display device is associated with a touch screen. In another such embodiment, the touch screen and a plurality of input devices, such as one or more mechanical input buttons, are associated with the first display device. The touch screen and mechanical input buttons are each configured to enable a player to make one or more inputs associated with the primary game displayed by the first display device. At block 104, the gaming system enables a player to make at least one input for the first game using at least one of the input buttons and/or the touch screen associated with the first display device of the gaming machine. In one example, the player changes a wager amount, designates a quantity of active paylines, and spins the reels of a slot game by interacting or making inputs with either the plurality of input buttons or the touch screen.

In one embodiment, the gaming system determines whether a designated input device reconfiguration event occurred at block 106. In one embodiment, the designated input device reconfiguration event occurs in association with the first game displayed by the first display device of the gaming machine. That is, in this embodiment, if a designated triggering symbol or triggering symbol combination occurs in the primary game, the gaming system determines that the designated input device reconfiguration event occurred for the gaming machine. In one embodiment, the designated input device reconfiguration event includes the player making a designated input, such as by activating a designated input button on a button panel associated with the gaming machine. In another embodiment, the designated input device reconfiguration event includes the player making a designated input using the touch screen associated with the gaming machine, such as by activating a designated area on the touch screen. In such embodiments, if the player makes the designated input using either the input buttons or the touch screen at the gaming machine, the gaming system determines that the designated input device reconfiguration event occurred for that gaming machine.

If the gaming system determines that the designated input device reconfiguration event did not occur at block 106, the gaming system continues operation of the first game at the gaming machine and provides the player of that gaming machine any award or awards which result from the first game at block 108. On the other hand, if the gaming system determines that the designated input device reconfiguration event occurred at block 106, the gaming system displays the first game on the first display device (e.g., the central display device 16 illustrated in FIG. 1) and displays a second game on a second display device (e.g., the upper display device 18 illustrated in FIG. 1) at block 110. For example, if a bonus triggering symbol is generated in a play of the primary game displayed on the first display device, the gaming system displays a bonus game on the second display device.

In one embodiment, if the gaming system determines that the designated input device reconfiguration event occurred at block 106, the gaming system redefines or reconfigures the function of at least one of the input devices to enable a player to simultaneously make separate inputs for a plurality of games. For example, the gaming system configures a first one of the input devices to enable the player to make one or more inputs associated with the first game displayed on the first display device and the gaming system configures a second one of the input devices to enable the player to make one or more inputs associated with the second game displayed on the second display device. For example, the gaming system enables the player to simultaneously make separate inputs in association with the first game utilizing the touch screen and the second game utilizing one or more of the input buttons. In one embodiment, the gaming system enables the player to simultaneously make separate inputs for a plurality of games at the player's discretion (e.g., sequentially or simultaneously). In such embodiments, the gaming system maintains the association of one of the input devices (e.g., the touch screen) with the first game displayed on the first display device while reconfiguring the association of another one of the input devices with the second game display on the second display device. That is, after the designated input device reconfiguration event occurs, the gaming system enables a player to simultaneously make at least one input in association with the first game using at least one of the input devices (e.g., the touch screen) at block 112 and make at least one input in association with the second game using a different input device (e.g., at least one of the input buttons) at block 114. In one embodiment, the gaming system redefines or reconfigures at least one of the input devices (e.g., at least one of the input buttons) to associate the at least one input device with the second game displayed on the second display device. As indicated by block 114, after the designated event occurs, the gaming system enables a player to make at least one input for the second game using the redefined or reconfigured input device (e.g., at least one of the input buttons). By enabling the player to make separate inputs utilizing separate input devices for different games, the gaming system and method presents a configurable game presentation to the player.

The gaming system enables the player to simultaneously make separate inputs for both the first and second games utilizing different input devices at the gaming machine and provides the player of that gaming machine any award or awards which result from the first and second games at block 116. In one embodiment, one of the awards available to be provided to the player is based on both an outcome of the first game and an outcome of the second game. In this embodiment, the gaming system provides the player with an additional award that is available when the player plays both the first and second games substantially simultaneously or simultaneously. For example, if both of the first and second games generate a designated winning combination, the gaming system provides the player with the additional award. Process 100 enables the player to make one or more separate inputs in association with the first game and the second game which increases certain player's rate of play, possible awards, enjoyment and interaction with the first and second games.

In one embodiment, the gaming system determines whether a designated display device reconfiguration event occurred. In one such embodiment, after the gaming system determines that the designated display device reconfiguration event occurred, the gaming system displays the second game on the first display device and associates one of the input devices (e.g., the touch screen) with the second game displayed on the first display device and moves the first game to the second display device. In this embodiment, the occurrence of the designated display device reconfiguration event causes the first and second games to swap display locations (i.e., move to different locations). That is, the first game displayed on the first display device is swapped with the second game displayed on the second display device to provide the player with a configurable game presentation. For this configurable game presentation, the gaming system associates the touch screen with the second game displayed on the first display device and associates the input buttons with the first game which is displayed on the second display device. By enabling the player to swap display locations of the first and second games, the gaming system enables the player to focus on either the first or second game (i.e., the game displayed by the first display device) while simultaneously enabling the player to make one or more inputs associated with the other game (i.e., the game displayed on the second display device). For example, if the player triggers a bonus game, the gaming system displays the bonus game on the first display device so that the player can focus on and interact with the bonus game (e.g., a selected game) utilizing the touch screen and displays the primary game (e.g., a non-selected game) on the second display device so that the player maintains the ability to make one or more inputs associated with the primary game by using the input buttons.

In one embodiment, the gaming system enables a first player playing at a first gaming device in the gaming system to swap or trade second games with a second player playing at a second gaming device in the gaming system. In one embodiment, the gaming system identifies each gaming device in the gaming system with an indentifier, such as a designated gaming machine number, and the gaming system bases the swap or trade of certain games on the identifier. In this embodiment, the gaming system enables one or more players to interact with at least one other display device (e.g., primary or secondary display device) of at least one other gaming device. For example, a first player playing at a first gaming device in the gaming system interacts with the game displayed by a second gaming device being played by a second player in the gaming system. In this example, the gaming system reconfigures at least one input device at the first gaming device to operate with the game being played at the second gaming device.

In one such embodiment, the gaming system enables the players associated with the swapped or traded game to share any award, such as a progressive award, provided in association with the swapped or traded game. In another embodiment, the gaming system enables a player to swap or trade games with another player for an associated cost or fee. In this embodiment, the gaming system offers a first player playing at a first gaming device in the gaming system to swap or trade games and/or credits associated with that game with a second player playing at a second gaming device in the gaming system. That is, if the first player wants to trade games with the second player, the gaming system enables the first player to pay an associated cost or fee (e.g., a number of credits) to the gaming establishment and/or the second player to effect the swap or trade. The gaming system reconfigures at least one input device at the first gaming device to operate with the game swapped or traded from the second gaming device.

In another such embodiment, the first gaming device displays a poker game to the first player and the second gaming device displays a bingo game to the second player. After a designated display device reconfiguration event, at the first and/or second player's gaming device, the gaming system enables the first player to swap or trade the poker game for the bingo game displayed to the second player by the second gaming device and enables the second player to swap or trade the bingo game for the poker game displayed to the first player by the first gaming device. That is, after the designated display device reconfiguration event, in one embodiment, the first gaming device displays the bingo game previously displayed by the second gaming device and the second gaming device displays the poker game previously displayed by the first gaming device. In one embodiment, the gaming system provides a certain advantage or incentive for the trade, such as by associating a higher average expected payout with the poker game and/or the bingo game.

In one embodiment, the gaming system determines or allocates which input device(s) will be associated with the first game and which input device(s) will be associated with the second game after the designated input device reconfiguration event occurs. In one embodiment, the gaming system maintains a plurality of different predefined input device configurations for the plurality of input devices. For example, in a first input device configuration, a first input device has a first function associated with the primary game and a second input device has a first function associated with the primary game. In this example, for a second input device configuration, the first input device has the first function associated with the primary game and the second input device is reconfigured to have a second function associated with a bonus game. That is, after the designated input device reconfiguration event occurs, the gaming system reconfigures the function of at least one of the input devices based on the plurality of different predefined input device configurations.

In one embodiment, the gaming system displays a plurality of input device configurations to the player via one or more service windows (not shown) which are displayed on the first and/or second display device. In one such embodiment, the gaming system utilizes one or more service windows, pop-up windows or non-overlapping windows, such as described in U.S. Published Patent Application No. 2007/0243925 to convey any suitable information, such as at least one input device and its associated function, to the player. In one such embodiment, the gaming system is configured to explain the functionality of the input device(s) via messages or instructions displayed by one or more such service windows, pop-up windows or non-overlapping windows.

In another embodiment, the gaming system enables the player to select or allocate which input device(s) will be associated with the first game and which input device(s) will be associated with the second game after the input device reconfiguration event occurs. In one such embodiment, the gaming system enables the player to pick a first input device (e.g., a spin button) to operate the first or primary game and a second input device (e.g., the bet buttons and the payline buttons) to operate with the second or bonus game. It should be appreciated that each of the input buttons of this embodiment are considered as a separate input devices.

In one embodiment, the central server of the gaming system communicates information or messages to the gaming device processor to redefine or reconfigure the function of one or more input devices for that gaming device. For example, the gaming machine processor enables a player to make one or more inputs associated with a first game displayed on a first display device using a first input device and/or a second input device. In this example, based on information or messages from the central server, the gaming machine processor enables the player to make one or more inputs associated with the first game displayed on the first display device using the first input device and enables the player to make one or more inputs associated with a second game displayed on a second display device using the second input device.

In one embodiment, the gaming system includes at least one designated input device, such as a dual mode button, which simultaneously activates play on both the first game and the second game. In one such embodiment, actuation of the designated input device constitutes the designated input device reconfiguration event. For example, if the player actuates the designated input device, the gaming system reconfigures at least one of the input devices such that the player can simultaneously make inputs for the first and second games displayed by the first and second display devices. That is, the player can simultaneously make a first input utilizing the first input device for the first game and a second input utilizing the second input device for the second game.

In one embodiment, at least one designated input device enables the player to initiate play of the first and second games substantially simultaneously or simultaneously. In one such embodiment, the designated input device is a dedicated button or input device on the button or input device panel. In another such embodiment, the designated input device is a dynamic button or input device (i.e., the gaming system reconfigures one of the input devices, such as the play button, to enable the player to initiate play of the first and second games substantially simultaneously or simultaneously). In one such embodiment, the gaming system enables the player to pick which of the input devices for the gaming system to reconfigure as the designated input device. In another embodiment, the gaming system utilizes one or more service windows, pop-up windows or non-overlapping windows to display the designated input device.

In one embodiment, at least one designated input device enables the player to make an input for at least two separate games substantially simultaneously or simultaneously. That is, in this embodiment, the player presses or otherwise actuates the designated input device to make separate inputs on at least two different games. For example, the player actuates one designated input device (e.g., a BET MAX FOR BOTH GAMES button) to place a maximum wager for each of the first and second games. In another example, one designated input device (e.g., a REPEAT BET and/or PAYLINE FOR BOTH GAMES button) enables the player to repeat at least one of the player's previous wager amount and/or the player's previous game play feature or characteristic (e.g., payline) from a previous play of both the first game and the second game. For example, the player actuates the designated input device to repeat the player's wager and payline selection from a previous play of the first and/or second game.

In one embodiment, the gaming system employs at least one designated input device which enables the player to designate a wager ratio between the first and second games. For example, a first designated input device enables the player to play both the first and second games at a designated wager ratio (e.g., five credits to one credit). That is, in this example, a single actuation of the first designated input device enables the player to place a first wager of five credits for the first game and a second wager of one credit for the second game. In another embodiment, the gaming system employs at least one designated input device which enables the player to designate a game feature ratio between the first and second games. For example, a second designated input device enables the player to play both the first and second games with a designated game feature ratio (e.g., three wagered on paylines to two wagered on paylines). That is, in this example, a single actuation of the second designated input device enables the player to place a designated wager (e.g., one credit or a maximum number of credits) on a designated number of paylines (e.g., three wagered on paylines) for the first game and enables the player to place a designated wager (e.g., one credit or a maximum number of credits) on a designated number of paylines (e.g., two wagered on paylines) for the second game.

In one embodiment, the gaming system enables one or more players to define a plurality of different input device configurations for the plurality of input devices. That is, an individual player inputs one or more rules or preferred configurations regarding the reconfiguration of the function and/or location of at least one input device. For example, although the physical location of a plurality of mechanical buttons would not change, the gaming system enables the player to reconfigure the button display and/or function of the mechanical buttons so that the button panel of that player's gaming device is customized to that player. In one embodiment, the gaming system saves the player's rules or preferences regarding the reconfiguration of one or more input devices to the player's player tracking card. In another embodiment, the gaming system maintains the player's rules or preferences regarding the reconfiguration of one or more input devices for that player's gaming session.

In one embodiment, the player selectively actuates a virtual input device controlled by the gaming device processor and/or the central server to make one or more inputs for the first game and/or the second game. In this embodiment, the gaming system enables the player to define or set a plurality of input rules which the gaming device processor and/or the central server rely on to make virtual inputs for the player using the virtual input device. For example, the player instructs the gaming device processor and/or the central server to play the first game at a certain wager, wherein a component or part of that wager is allocated to simultaneous play of the second game. In one such embodiment, the gaming device reconfigures a designated one of the input devices to enable the player to modify the virtual input rules or preferences. In different embodiments, the designated input device enables the player to start or stop simultaneous play of two games, switch the game focus (e.g., swap the display location of two games), modify the wager amounts for one or both of the games, or modify any suitable characteristic or feature of one or both of the games. For example, the designated input device enables the player to instruct the gaming system to cause the primary display device to display the second game and additionally allocate a higher proportion of that player's total wager amount to the second game. In this example, the gaming system causes the primary display device to display the first game and the secondary display device to display the second game with a designated wager ratio of five credits (for the first game) to three credits (for the second game). Continuing with this example, if the second game becomes more interesting to the player (e.g., a bonus triggering event occurs in association with the second game), the gaming system enables the player to actuate the designated input device to switch the second game to the primary display device and to modify the wager placed on the first and/or second games.

In another embodiment, the gaming device processor and/or the central server determines which options (e.g., a wager ratio between the first game and the second game) to provide or offer the player. In this embodiment, the gaming system enables the player to accept the determined options so that the gaming device processor and/or the central server make virtual inputs for the player until the player manually overrides such virtual inputs. If the player rejects the determined options, the player continues making manual inputs in association with the first game and/or the second game. It should be appreciated that the gaming system communicates any suitable messages, information or instruction to the player regarding the virtual input rules and manual overrides. For example, the gaming system notifies the player if certain game requirements (e.g., such as a maximum wager requirement) will not be met if e player manually overrides the virtual inputs.

In different embodiments, the designated input device reconfiguration event and/or the display device reconfiguration event includes, but is not limited to:
(1) a deposit of an amount of funds at the gaming device;
(2) an identification of a player (or a designated player) at the gaming device;
(3) any player (or a designated player) placing a wager (regardless of the wager amount);
(4) any player (or a designated player) placing a side-wager (regardless of the side-wager amount);
(5) any player (or a designated player) wagering on a number of paylines;
(6) any player (or a designated player) wagering on a designated payline;
(7) any player (or a designated player) wagering on a number of ways to win;
(8) any player (or a designated player) engaging an input device of the gaming device to cause a generation of an outcome;
(9) an activation of a reel (or a designated reel);
(10) an activation of a plurality of reels;
(11) a generation of any outcome (or a designated outcome);
(12) a generation of any outcome (or a designated outcome) associated with an award;
(13) a generation of any outcome (or a designated outcome) associated with an award over a designated value;
(14) a generation of an outcome (or a designated outcome) on a designated payline;
(15) a generation of an outcome (or a designated outcome) in a scatter configuration;
(16) a generation of a winning way to win (or a designated winning way to win);
(17) a generation of a designated symbol or symbol combination;
(18) a generation of a designated symbol or symbol combination on a designated payline;
(19) a generation of a designated symbol or symbol combination in a scatter configuration;
(20) an eligible gaming device providing any player (or a designated player) an award amount;
(21) a triggering of a play of a secondary game;
(22) an activation of a secondary display (such as an award generator);
(23) an activation of a community award generator;
(24) a generation of any outcome (or a designated outcome) in a secondary game;
(25) any player (or a designated player) engaging an input device of the gaming device to make a selection in a game;
(26) an amount of free spins provided;
(27) an amount of time elapsed;
(28) any event disclosed herein which is tracked for a group of gaming devices;
(29) any event disclosed herein which includes a group of gaming devices working together;
(30) any event disclosed herein which is associated with a group of players working together; and/or
(31) any suitable event which occurs in association with a player's gaming experience.

In different embodiments, the gaming system prioritizes the designated input device reconfiguration event and/or the display device reconfiguration event to determine which game the primary display device and the secondary display device display. In one such embodiment, the display device reconfiguration event includes an event which occurs in the play of the first game and/or the second game (e.g., a triggering of a play of a bonus game). For example, if a bonus triggering event occurs in the second game displayed by the secondary display device, the gaming system causes the primary display device to display the second game so that the player can focus on the bonus event of the second game and the gaming system causes the secondary display device to display the first game.

In another such embodiment, the display device reconfiguration event is based on the player's wager amount, wherein the primary display device displays the game in which the player has placed the higher wager amount. For example, if a player wagers one credit on a play of a first game and wagers five credits on a play of a second game, the gaming system causes the primary display device to display the play of the second game and causes the secondary display device to display the play of the first game based on the player's wager amounts for the first and second games. In another such embodiment, the display device reconfiguration event is based on the player's award amount, wherein the primary display device displays the game in which the player has won the most awards (or an award with a higher value). For example, if the player wins more awards (or awards of higher values) on plays of the first game relative to plays of the second game, the gaming system causes the primary display device to display the first game and causes the secondary display device to display the second game. In such embodiments, the gaming system reconfigures the functionality of one or more of the input devices depending on which of the first and second display devices displays the first game and which of the first and second display devices displays the second game.

In one embodiment, the gaming system enables the player to input or select the priority of the designated input device reconfiguration event and/or the display device reconfiguration event. In this embodiment, the gaming system enables the player to rank the events into a hierarchy followed by the gaming system to prioritize the designated input device reconfiguration event and/or the display device reconfiguration event to determine which game the primary display device and the secondary display device display. For example, if the player prioritizes or ranks the player's wager amount higher than the player's number of wagered on paylines, the gaming system determines which games the primary and secondary display devices display based on the player's wager. If the gaming system determines that the player has wagered the same amount on both games displayed by the first and second display devices, the gaming system determines which games the primary and secondary display devices display based on the player's wagered on number of paylines.

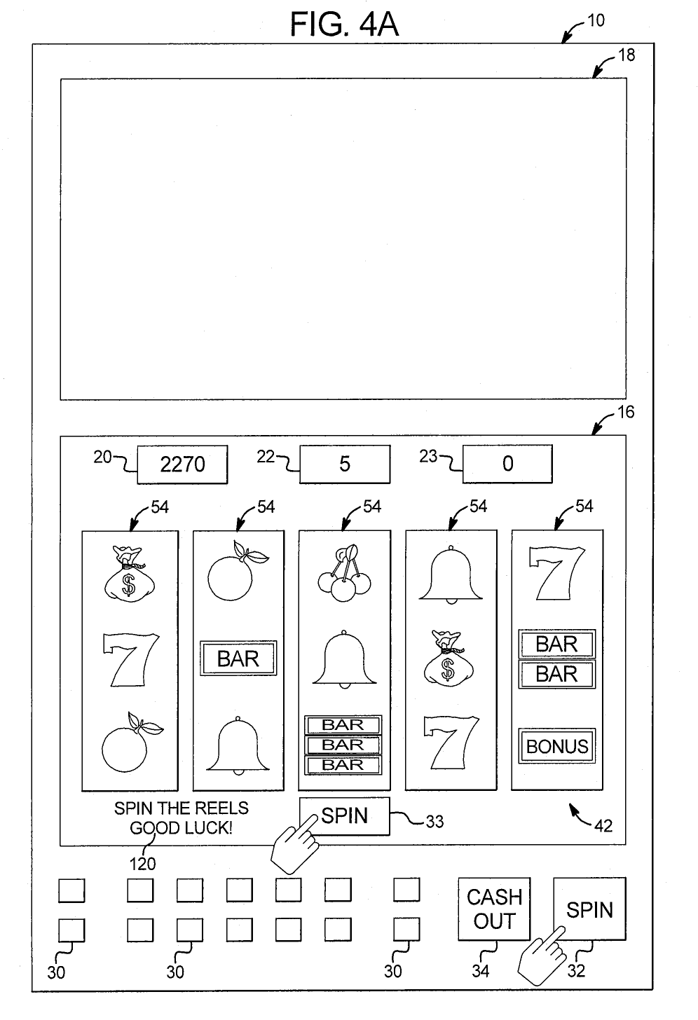

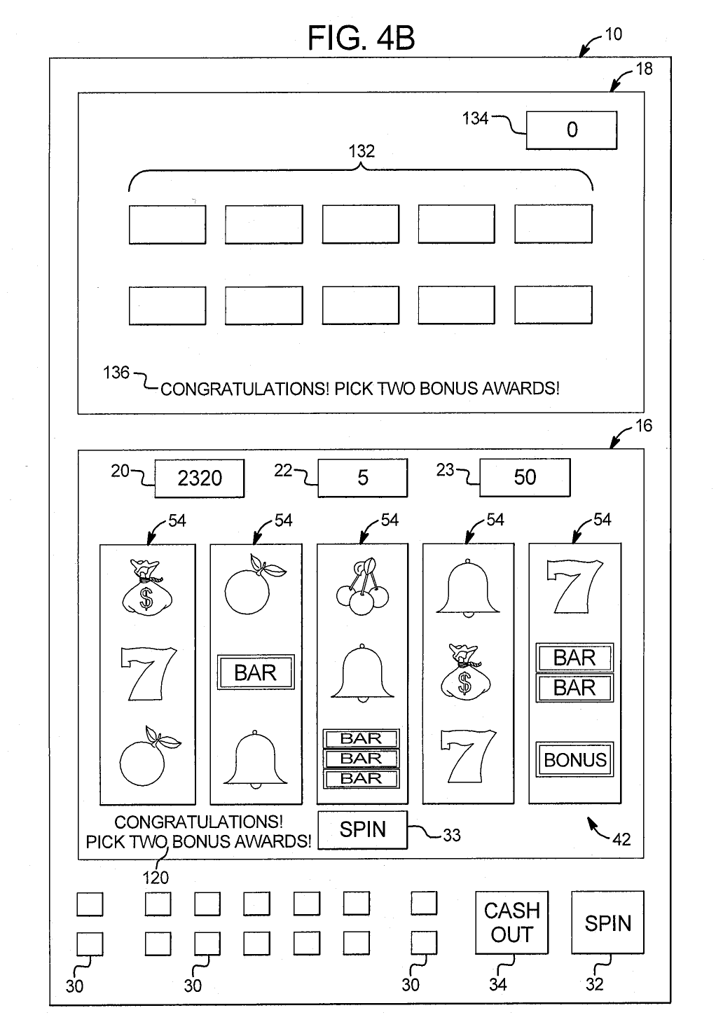

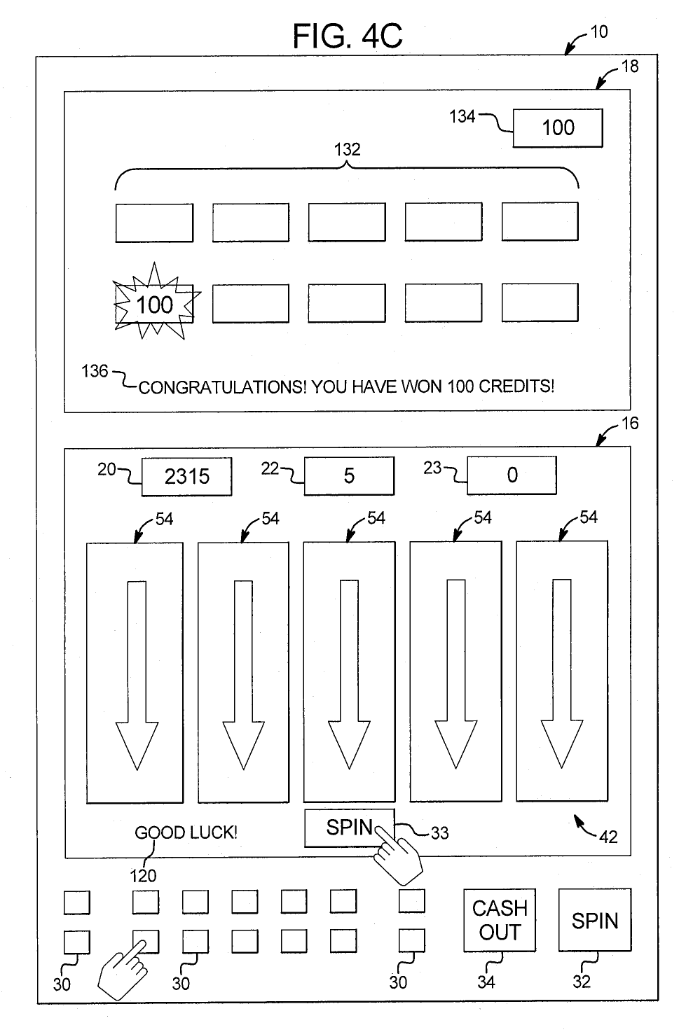

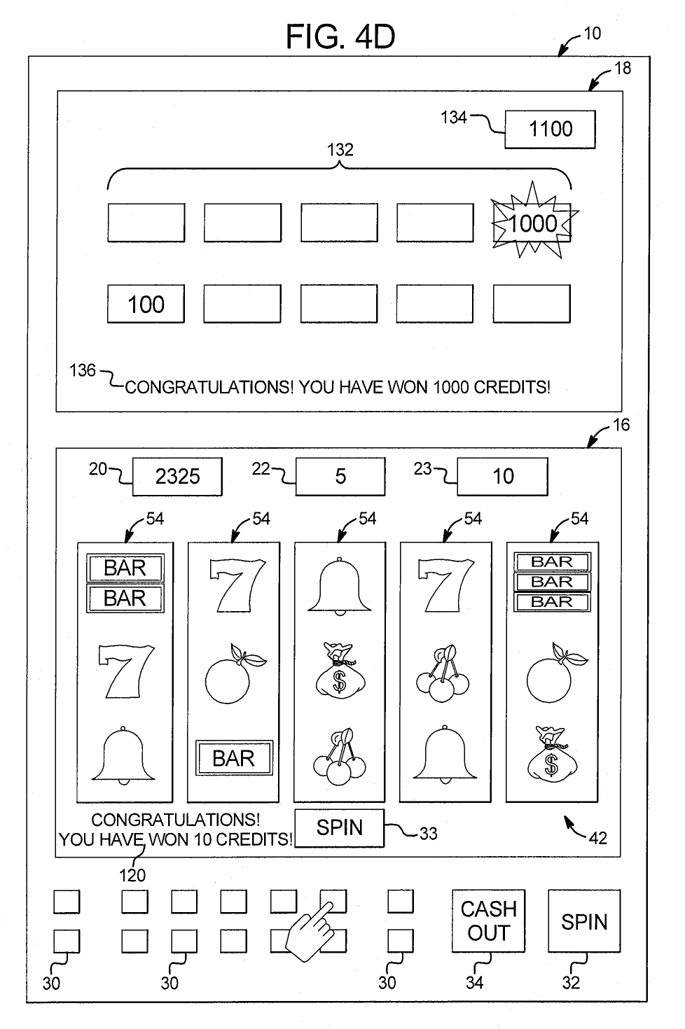

Referring now to FIGS. 4A, 4B, 4C and 4D, one gaming device 10 is illustrated in accordance with one embodiment of the disclosed gaming system. As described above, the gaming device 10 includes the central or primary display device 16, the upper or secondary display device 18 and a plurality of input devices 30. In the embodiment illustrated in FIG. 4A, the central display device 16 displays a plurality of reels 54 for a primary game.

In one embodiment, after appropriate funding of the gaming device, one input device is a game activation device, such as a play button 32 or a pull arm (not shown) which is used by the player to start any primary game or sequence of events in the gaming device. The play button can be any suitable play activator such as a bet one button, a max bet button, or a repeat the bet button. In one embodiment, upon appropriate funding, the gaming device begins the game play automatically. In another embodiment, upon the player engaging one of the play buttons, the gaming device automatically activates game play.

In one embodiment, one input device is a bet one button. The player places a bet by pushing the bet one button. The player can increase the bet by one credit each time the player pushes the bet one button. When the player pushes the bet one button, the number of credits shown in the credit display 20 preferably decreases by one, and the number of credits shown in the bet display 22 preferably increases by one. In another embodiment, one input device is a bet max button (not shown) which enables the player to bet the maximum wager permitted for a game of the gaming device.

In one embodiment, one input device is a cash out button 34. The player may push the cash out button 34 and cash out to receive a cash payment or other suitable form of payment corresponding to the number of remaining credits.

In one embodiment, as mentioned above, one input device is the touch-screen 42 coupled with the touch-screen controller 44 or some other touch-sensitive display overlay to allow for player interaction with the images on the display. A player can make decisions and input signals into the gaming device by touching the touch-screen at the appropriate locations. One such input device is a conventional touch-screen button panel.

The central display device 16 displays an award display 23. The award display 23 displays the amount of any awards provided as a result of the play of the primary game (i.e., based on the symbols or indicia generated on the reels 54). In the embodiment illustrated in FIG. 4A, the credit display 20 indicates that the player has 2270 available credits and the bet or wager display 22 indicates that the player has bet 5 credits for this play of the primary game.

The gaming device 10 includes a plurality of the input devices 30 which communicate with the gaming device processor in response to player manipulation. In this embodiment, the input devices 30 include, but are not limited to, a bet one button, a max bet button, at least one payline button, the play button 32, a touch screen play button 33, the cash out button 34. In the embodiment illustrated in FIG. 4A, after the player has placed a wager for the primary game using the input devices 30 or the touch screen 42, the player either presses the play button 32 or touches the touch screen play button 33 to start the primary game or any sequence of events in the gaming device 10. That is, the gaming device 10 enables the player to make an input for the primary game using at least one of: a first input device (e.g., pressing the play button 33 using the touch screen 42) and a second input device (e.g., pressing the play button 32 or another one of the input devices 30).

In one embodiment, the central display device 16 displays a message or instruction area 120 which can display messages or instructions to the player. In one embodiment, the central controller of the gaming system is programmed to control which messages or instructions are displayed by the message area 120. Appropriate messages or instructions such as “SPIN THE REELS” or “GOOD LUCK!” may be provided to the player visually, or through suitable audio or audiovisual displays.

When the primary game starts, the reels 54 spin. Once the reels 54 stop spinning, the gaming device 10 or the central server of the gaming system evaluates the symbols or indicia generated by the spin and determines whether the generated symbols or indicia result in any awards. In the embodiment illustrated in FIG. 4B, the reels 54 have generated a bonus symbol 128. In this embodiment, the bonus symbol 128 is associated with an award of 50 credits and represents a triggering symbol for a bonus or secondary game 130. The award display 23 indicates that the player has won 50 credits for this play of the primary game and the credit display 20 indicates that the player has 2320 available credits after obtaining the bonus symbol 128.

In the embodiment illustrated in FIG. 4B, the upper display device 18 is configured to display the bonus or secondary game 130. In this embodiment, the bonus game includes a selection game having a plurality of player selectable selections 132. Each of the selections 132 is associated with at least one award value, which is masked or covered prior to being selected by the player.

In one embodiment, the upper display device 18 displays a message or instruction area 136 which can display messages or instructions to the player. In one embodiment, the central controller of the gaming system is programmed to control which messages or instructions are displayed by the message area 136. As seen in FIG. 4B, in one embodiment, the message or instruction areas 120 and 136 of the central and upper display devices 16 and 18 provide appropriate messages or instructions to the player such as “CONGRATULATIONS! PICK TWO BONUS AWARDS!” or “PICK UNTIL YOU LOSE!” visually, or through suitable audio or audiovisual displays.

The upper display device 18 displays a bonus award display 134 which displays the amount of any awards provided as a result of the play of the bonus game. In the embodiment illustrated in FIG. 4B, the bonus award display 134 displays the amount of any awards provided to the player based on the selections 132 picked by the player.

In the embodiment illustrated in FIG. 4C, the gaming system redefines or changes the functions of at least one of the input devices 30 to enable the player to simultaneously make one or more inputs in association with the bonus game 130 and make one or more inputs in association with the primary game displayed on the central display device 16. That is, in this embodiment, the gaming system enables the player to make one or more inputs for the bonus game 130 utilizing a first one of the input devices while simultaneously enabling the player to make one or more inputs for the primary game utilizing a second one of the input devices.

In one embodiment, the gaming system redefines or changes the functions of at least one of the input devices 30 in response to the generation of the bonus symbol 128 in the primary game. That is, at a first time when only the primary game is displayed on the central display device 16, each of a plurality of the input devices 30 enable the player to make separate inputs for the primary game. At a second time when both the primary and bonus games are displayed, the gaming system simultaneously configures a first one of the input devices 30 to enable the player to make one or more inputs associated with the primary game (e.g., the touch screen 42) and a second, different one of the input devices to enable the player to make one or more inputs associated with the bonus game 130 (e.g., the input devices 30).

In the embodiment illustrated in FIG. 4C, the gaming system redefines the functionality of at least one of the input devices 30 such that each one of the input devices 30 corresponds to each one of the selections 132 in the bonus game 130. In this embodiment, the input devices 30 includes a plurality of mechanical input buttons which correspond to a single input device that functions with the bonus game 130. In the embodiment illustrated in FIG. 4C, a plurality of the input devices 30 and the selections 132 are arranged in a similar pattern to help the player identify which of the input devices correspond to a particular selection. For example, as seen in FIG. 4C, the top row of input devices correspond to the top row of selections and the leftmost input device of the top row corresponds to the leftmost selection of the top row.

As illustrated in FIG. 4C, the player has actuated the play button 33 on the touch screen 42 to spin the reels 54 in the primary game. The credit display 20 indicates that the player has 2315 credits remaining after placing a wager of 5 credits. The reels 54 spin after the player places the wager and actuates the play button 32 or 33. It should be appreciated that actuation of the mechanical input button 32 or actuation of the designated area 33 of the touch screen 42 causes the reels 54 to spin after the player places the wager. As also illustrated in FIG. 4C, the player has actuated one of the input devices 30 to pick a selection 132 in the bonus game 130. Once the player picks one of the selections 132, the picked selection is uncovered to reveal an award, as mentioned above, such as an award value, a multiplier or a number of additional picks. As illustrated in FIG. 4C, the picked selection is highlighted and associated with an award of 100 credits. The player has won 100 credits as indicated by the award display 134 and the message area 136.

In one embodiment, the gaming device 10 displays which of the input devices 30 correspond to each one of the selections 132 via one or more service windows displayed on the central display device 16 and/or the upper display device 18. For example, the gaming system causes a first one of the input devices to display “SELECTION ONE” and a first one of the selections to display “SELECTION ONE” so that the player can identify the relationship between the input device and the corresponding selection.

In another embodiment, the central controller of the gaming system dynamically changes the input devices 30 to indicate the corresponding selections 132. That is, at least one of the input devices 30 is a dynamic or changeable button, which enables a button display and a button function to be changed by, or downloaded from, the central server or controller. In one such embodiment, the downloadable dynamic buttons enable customization with different games provided by the gaming system manufacturer and/or the gaming system operator. For example, in a slot game, a dynamic button lights up and shows an appropriate button display or tile (e.g., SPIN THE REELS) while in a poker game, the dynamic button lights up and shows a different display or tile (e.g., DEAL).

In different embodiments, the button display includes, without limitation, a plasma display, a liquid crystal display (LCD) a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs), a display including a projected and/or reflected image, or any other suitable electronic device or display mechanism. It should be appreciated that the dynamic input devices or buttons are each associated with at least one button display that is configured to be changed by the gaming device processor and/or the central sever depending upon the primary game and/or the bonus game.

Referring now to FIG. 4D, the reels 54 for the primary game displayed on the central display device 16 have stopped spinning. The reels 54 have generated a winning symbol combination associated with an award. As seen in FIG. 4D, the award has a value of 10 credits which is indicated by the award display 23 and added to the credit display 20. The message area 120 displays an appropriate message to visually or audio-visually indicate the award to the player.

As illustrated in FIG. 4D, the player has actuated a second one of the input devices 30 to pick a second one of the selections 132 in the bonus game 130. The picked selection is uncovered to reveal an award of 1000 credits. The award display 134 indicates that the player has won 1100 credits in the bonus game 130. In one embodiment, any credits indicated by the award display 134 associated with the bonus game 130 are added to the player's credit display 20 when the bonus game 130 ends. The message area 136 displays an appropriate message 136 such as “CONGRATULATIONS! YOU HAVE WON 1000 CREDITS!”

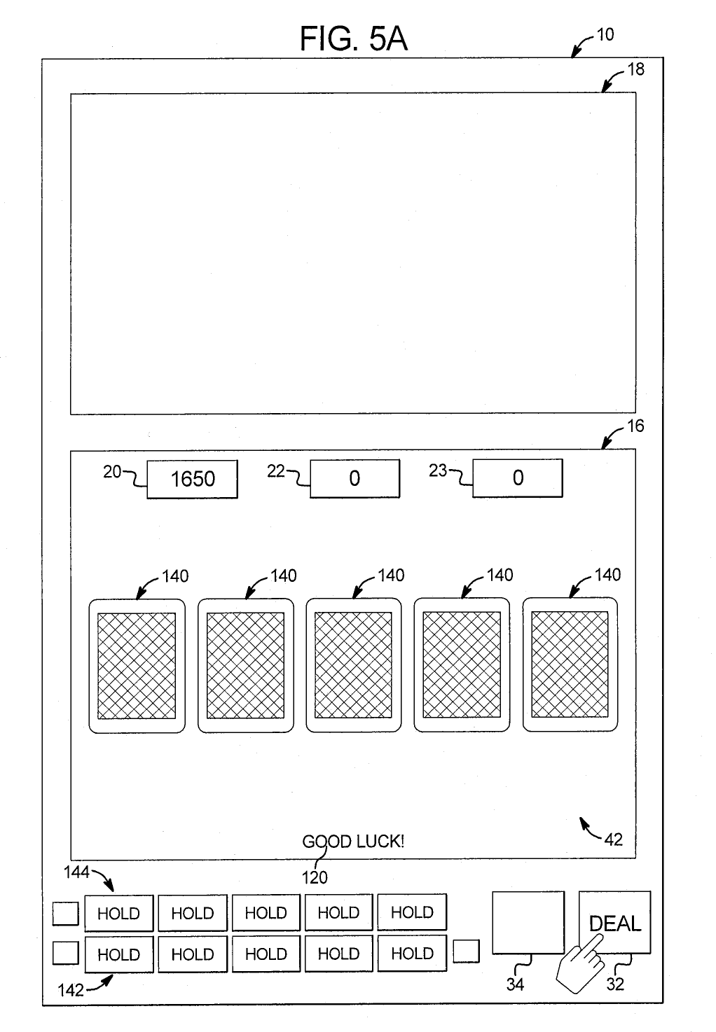

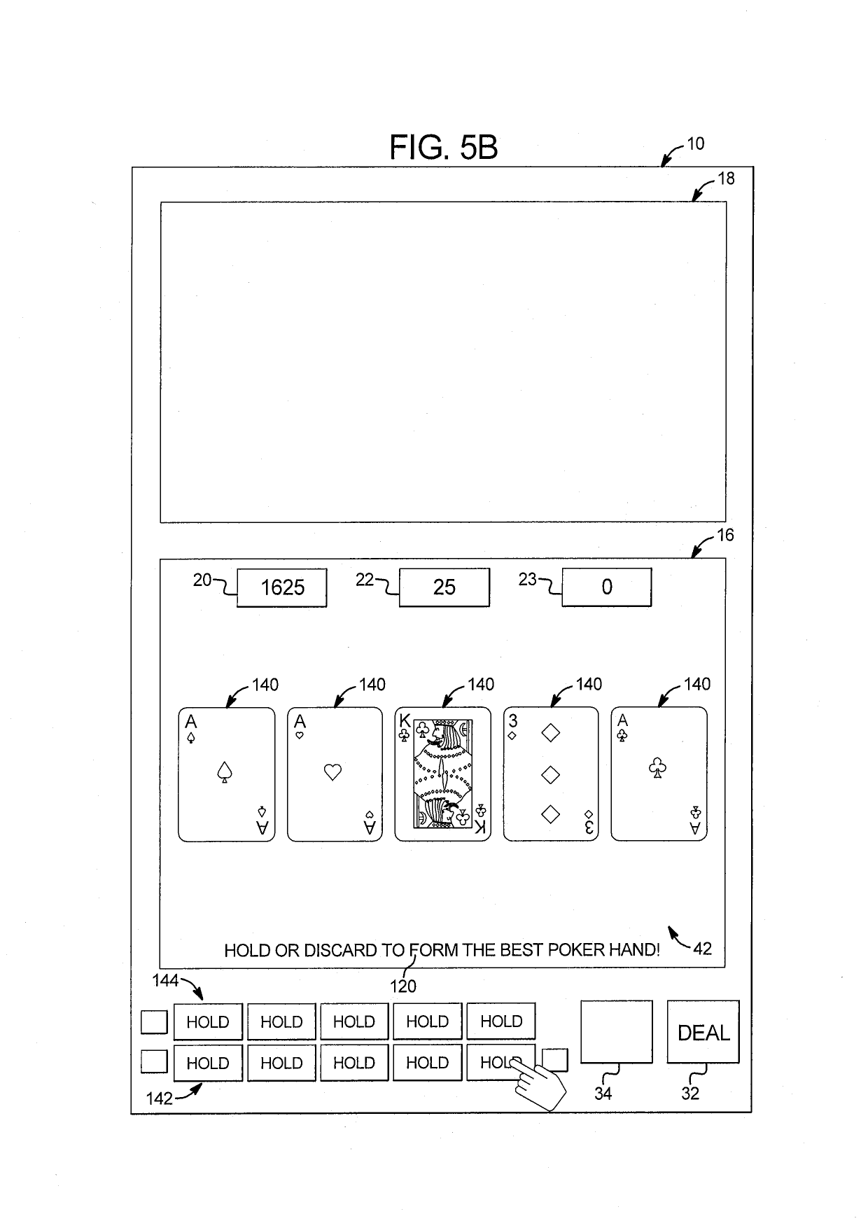

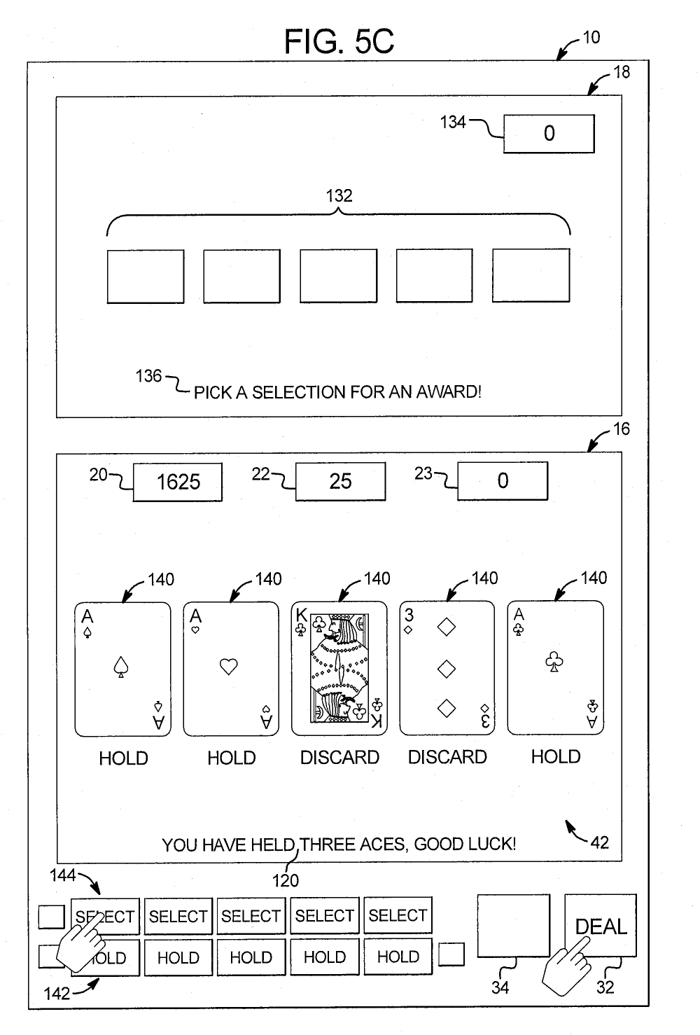

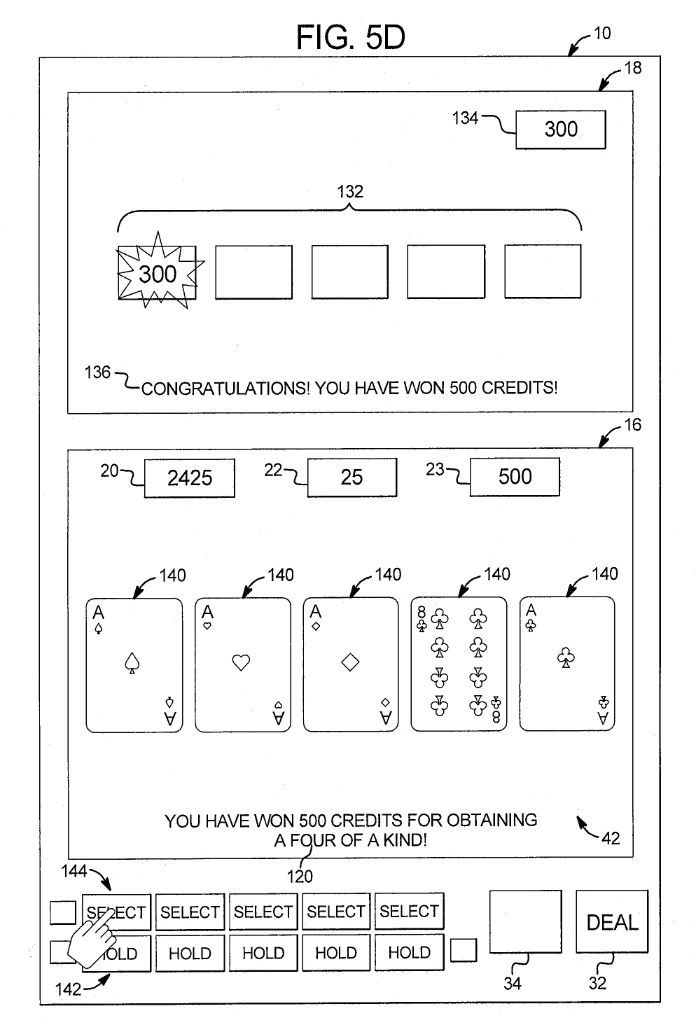

Referring now to FIGS. 5A to 5D, one gaming device 10 is illustrated in accordance with one embodiment of the disclosed gaming system. In this embodiment, a first processor (e.g., the gaming device local processor) causes the central display device 16 to display a poker game including a plurality of playing cards 140. In this embodiment, a first set 142 of a first type of input devices and a second set 144 of a first type of input devices are configured to operate with the poker game displayed on the central display device 16. In this embodiment, a second processor (e.g., the central server) causes the upper display device 18 to display a second game including a plurality of selections 132 after a triggering event. If the upper display device 18 displays the second game, the second processor takes control over the second set 144 of input devices from the gaming device processor and reconfigures such input devices to operate with the second game. That is, if the second game is displayed, the player uses the first set 142 of input devices to hold or discard certain of the playing cards 140 during the poker game and the player uses the second set 144 of input devices to pick one or more selections 132 in the second game.

In the embodiment illustrated in FIG. 5A, the credit display 20 indicates that the player has 1625 available credits. The wager display 22 indicates that the player has placed a wager of 25 credits. After placing the wager, the player actuates the play or deal button 32 which causes the gaming device processor to deal the player an initial poker hand. In one embodiment, the player actuates the touch screen 42 to cause the gaming device processor to deal the initial poker hand.

As seen in FIGS. 5B and 5C, the gaming device 10 dealt the player three aces, one king and one three. The player's initial poker hand includes a three of a kind. The message area 120 messages or instructs the player to hold or discard one or more of the playing cards 140. To hold or discard the playing cards 140, in the embodiment illustrated in FIGS. 5B and 5C, the player actuates a different one of the input devices of the first set 142 and/or the second set 144 to toggle each dealt playing card 140 between hold and discard (i.e., no hold). That is, each input device of the first and second sets 142 and 144 enable the player to hold or discard a corresponding playing card 140 dealt to the player. The gaming device 10 waits for the player to actuate the play or deal button 32 to deal replacement cards for any cards not held or discarded by the player.

In the embodiment illustrated in FIGS. 5B and 5C, the player's initial poker hand (e.g., a three of a kind) serves as a triggering event for a bonus game 150. After the triggering event, the second processor (e.g., the central server) causes the upper display 18 to display the bonus game 150. The bonus game 150 includes a plurality of selections 152 associated with a plurality of awards. The second processor also takes control over each one of the input devices of the second set 144 from the gaming device processor. That is, the second processor causes each one of the input devices of the second set 144 to correspond to one of the selections 152 of the bonus game 150. As illustrated in FIG. 5C, the second processor has reconfigured each of the second set 144 of input devices to display “SELECT” instead of “HOLD” to represent their changed function. The second processor causes each one of the input devices of the second set 144 to enable the player to pick a corresponding one of the selections 152 (to interact with the bonus game 150) using the input devices of the second set 144 while simultaneously interacting with the primary game using the input devices of the first set 142.

In this embodiment, the first set 142 and the second set 144 of input devices operate either sequentially or simultaneously with different games controlled by multiple processors. That is, the gaming system reconfigures one, a plurality of, or each input device based on a plurality of processors at multiple locations. At a first point in time, the input devices of the second set 144 are configured to operate with the gaming device processor in association with the poker game and playing cards 140 while at a second point in time, the second processor reconfigures the input devices of the second set 144 to operate with the bonus game 150. Although the second processor controls the input devices of the second set 144, it should be appreciated that the second processor operates or communicates with the gaming device processor regarding events and awards that occur during the bonus game 150.

As illustrated in FIGS. 5C and 5D, the player has actuated a first input device (e.g., the leftmost input device) of the second set 144 which corresponds to a first selection (e.g., the leftmost selection) of the bonus game 150. The picked selection 152 is associated with an award of 300 credits. The second processor communicates with the gaming device processor to cause the gaming device 10 to provide the award to the player. The award display 136 indicates the amount of the award provided to the player from the bonus game 150.

As seen in FIG. 5D, the gaming device processor caused two replacement cards 140 to be dealt to the player in response to the player's actuation of the play or deal button 32. The player obtained a four of a kind and won an award of 500 credits. The award display 23 indicates the amount of the award provided to the player from the primary game. In one embodiment, the bonus award (e.g., 300 credits) indicated on the award display 136 and the primary game award (e.g., 500 credits) indicated on the award display 23 are both added to the player's credits displayed by the credit display 20. As indicated in FIG. 5D, the credit display 20 indicates that the player has 2425 credits (e.g., 1625 credits+500 credits+300 credits).

It should be appreciated that the gaming device 10 includes at least one input device for the primary game that can be reconfigured by the second processor to operate with the bonus game so that the player can interact with both the primary game and the bonus game substantially simultaneously or simultaneously. For example, as illustrated in FIGS. 5C and 5D, the gaming device 10 enables the player to actuate one of the input devices of the second set 144 at the same time (or substantially at the same time) as the play or deal button 32.

It should be appreciated that the gaming system can dynamically redefine or change the first set 142 of input devices or the second set 144 of input devices depending upon the primary game and/or the bonus game. In one embodiment, the poker game displayed on the central display device 16 is associated with a first bonus game (e.g., a selection game) and a second bonus game (e.g., a high/low game). In this embodiment, the gaming system changes the second set 144 of input devices depending upon whether the first or second bonus game is triggered. That is, the second set 144 of input devices include dynamic input devices (or dynamic buttons). For example, if the first bonus game is triggered, the gaming device 10 operates substantially as described above with respect to FIGS. 5A to 5D. If the second bonus game is triggered, as in this example, the gaming system deals one card to the player and enables the player to guess whether the next card dealt will be higher or lower than the dealt card. To enable the player to interact with the high/low bonus game, the gaming system redefines the second set 144 of input devices to operate with the high/low bonus game. That is, the gaming system changes the function of one of the input devices of the second set 144 so that the player can pick a high value and the gaming system changes the function of another one of the input devices of the second set 144 so that the player can pick a low value. In one such embodiment, it should be appreciated that while different input devices of the second set 144 perform different functions in the bonus game, the gaming system enables the player to simultaneously make one or more inputs utilizing the first set 142 of input devices for the primary game.

In one embodiment, the gaming system causes the primary game displayed on the central display device 16 to switch or reconfigure display locations with the bonus or secondary game displayed on the upper display device 18. In this embodiment, at a first point in time, the gaming system causes the central display device to display the first game and causes the upper display device to display the second game. At a second point in time, such as after a designated display device reconfiguration event occurs, the gaming system reconfigures or moves the displayed location of the first and second games. That is, at the second point in time, the central display device displays the second game and the upper display device displays the first game. In one embodiment, the designated display device reconfiguration event occurs when the player actuates a designated display reconfiguration or swap button. Thus, as further described below, the player can move the display locations of the first and second games at the player's discretion.

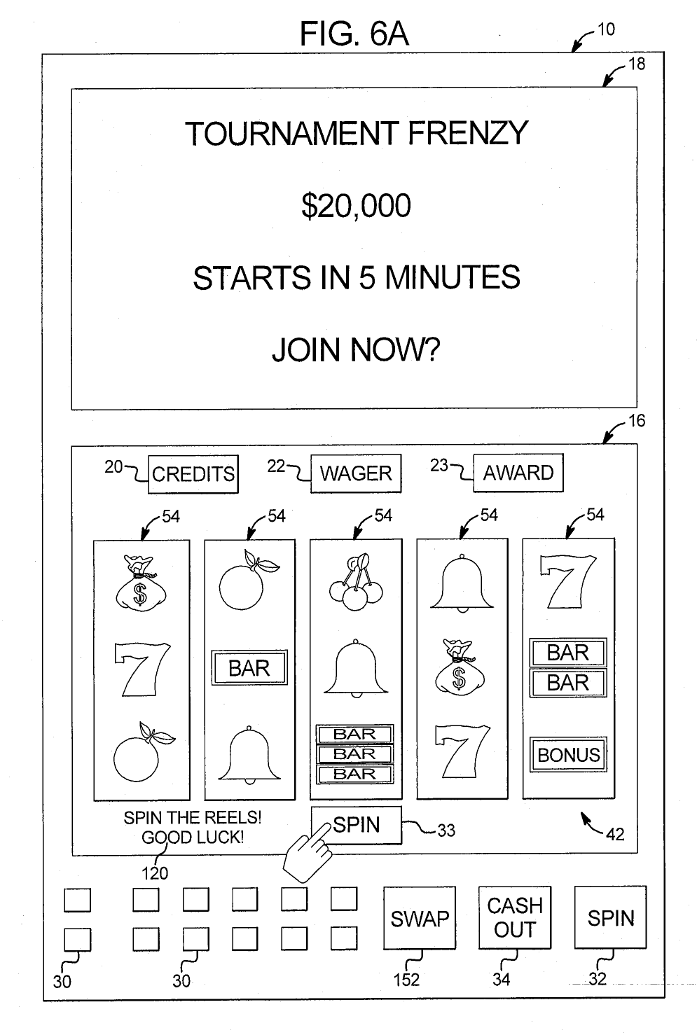

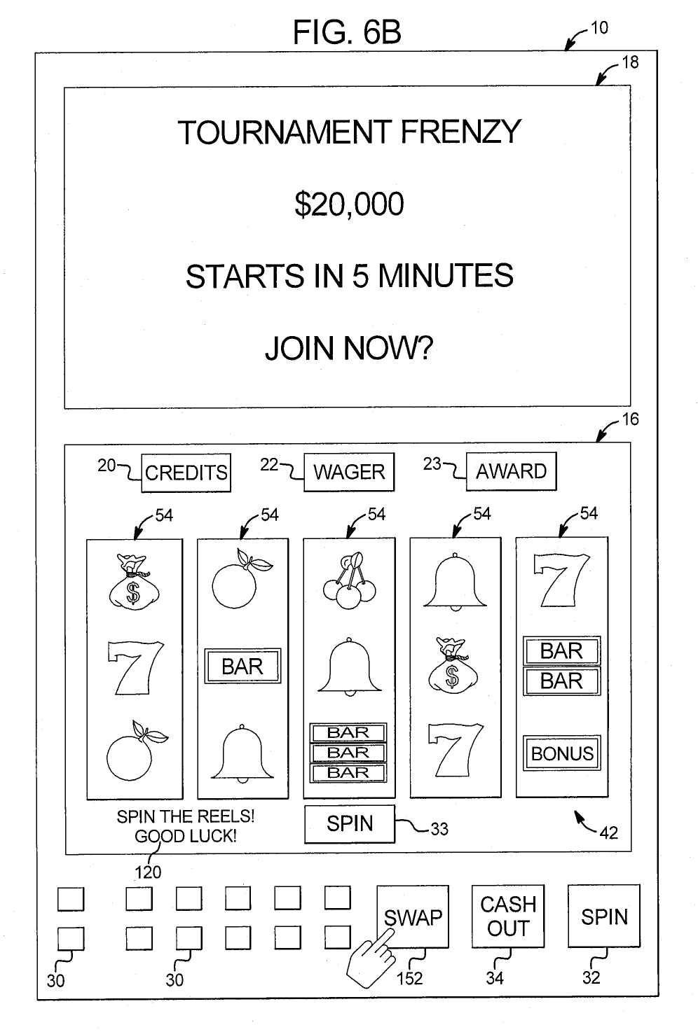

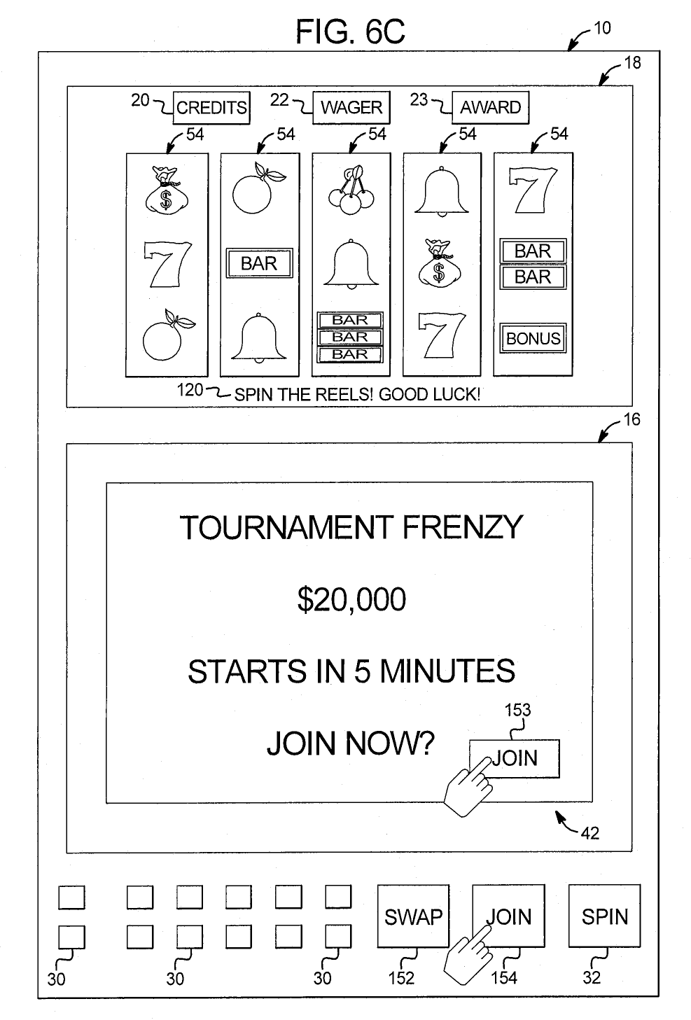

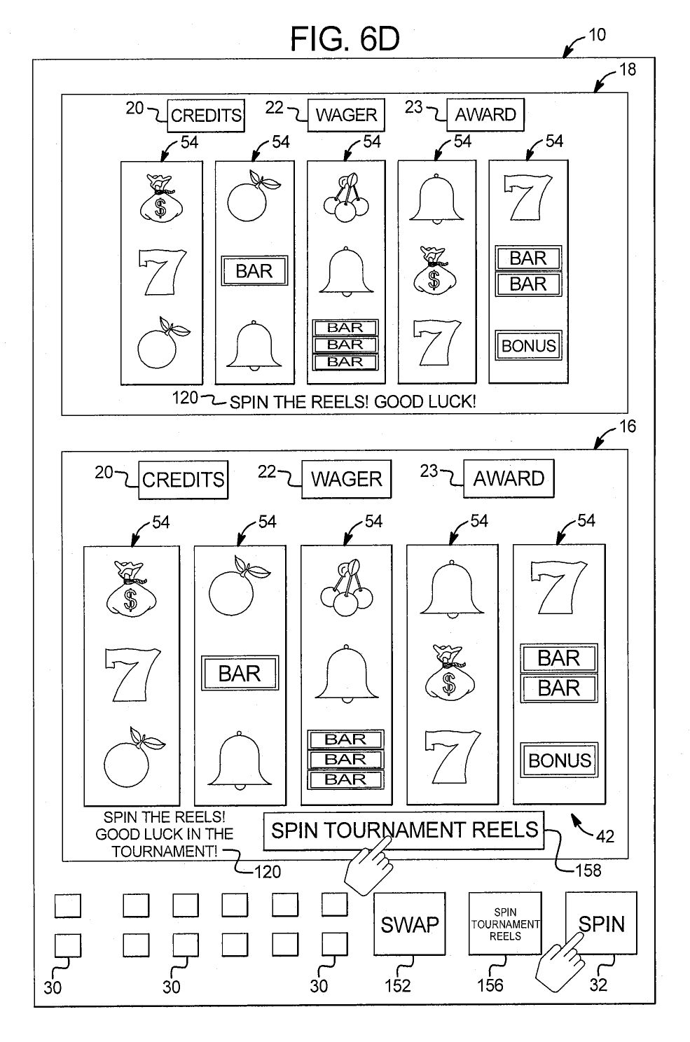

Referring now to FIGS. 6A to 6D, one gaming device 10 is illustrated in accordance with the disclosed gaming system. In this embodiment, the gaming device includes the central display device 16 and the upper display device 18. As illustrated in FIG. 6A, the central display device 16 displays a primary game including a plurality of reels 54 and the upper display device 18 serves as digital glass operable to advertise or offer a tournament. The tournament is associated with an award or award pool of $20,000.

In one such embodiment, the gaming system selects which of the gaming machines (or players) are eligible for the tournament based on any suitable criterion, such as the amount of wagers played in a designated period of time or the player's player tracking status as determined through a suitable player tracking system. In one embodiment, for a player to remain eligible for the tournament, that player must continue playing or interacting with the primary game. After the gaming system determines which gaming machines (or players) are eligible for the tournament, the gaming system broadcasts the offer to eligible gaming machines (or players) in the gaming system. In different embodiments, it should be appreciated that the tournament is associated with a single player award, a group award, or one or more progressive awards.

As illustrated in FIG. 6A, the gaming system broadcast the advertised tournament offer to the gaming device 10. The upper display device 18 of the gaming device 10 displays the tournament offer to the player of the gaming device 10. As illustrated in FIG. 6B, if the player wants to join the tournament, the player switches the tournament offer to the central display device 16 by actuating the “swap” button 154. In one embodiment, the gaming system enables the player to keep the tournament game displayed on the central display device 16 while enabling the player to make one or more inputs associated with the primary game displayed on the upper display device 18. In another embodiment, the gaming system changes the function of one or more of the input devices of the gaming device, such as the play or spin button 32, to enable the player to interact with or make separate inputs in association with the primary game when the primary game is displayed by the upper display device 18.

As illustrated in FIG. 6C, the central display device 16 displays the tournament offer and the upper display device displays the primary game including the reels 54. To join the tournament, the player actuates either a designated area 155 on the touch screen or actuates the join tournament button 156. In one embodiment, the player places a wager or pays a fee to enter the tournament. It should be appreciated that, in this embodiment, the gaming system dynamically changed the cash out button 34 to the join tournament button 156. This change enables the player to identify the different functions of the cash out button 34 depending upon whether the central display device 16 displays the primary game or the tournament offer.

In the embodiment illustrated in FIG. 6D, the central display device 16 displays the tournament. In this embodiment, the tournament includes a reel game and once the tournament starts, the gaming system dynamically changes the join tournament button to function as a spin tournament reels button 156. As seen in FIG. 6D, the gaming system changed the display of the button 156 from “JOIN” to “SPIN TOURNAMENT REELS” to indicate to the player that the function of the button 156 changed. The gaming system enables the player to make one or more inputs associated with the tournament game by using either the spin tournament reels button 156 or a designated spin tournament reels area 157 on the touch screen 42.

As seen in FIG. 6D, the upper display device displays the primary game. The gaming system enables the player to make one or more inputs associated with the primary game using the play or spin button 32. If the player elects to change betting options in the primary game, such as wager amount or payline selection, the gaming system enables the player to move the primary game to the central display device 16 and to move the tournament game to the upper display device 18 by actuating the “swap” button 154. If the player switches the display locations of the primary game and the tournament game, the gaming system enables the player to simultaneously make one or more inputs in association with the primary game using either the play or spin button 32 or a designated area of the touch screen 42 and make one or more inputs in association with the tournament game using the spin tournament reels button 156. In this embodiment, the gaming system provides the player with any awards resulting from the tournament game and the primary game.

In one embodiment, the central display device 16 of each of a plurality of the gaming devices 10 displays a primary game. In one such embodiment, a plurality of the gaming devices 10 are associated with different primary games. In one embodiment, the central display device 16 of each of a plurality of the gaming devices 10 displays a first type of game (e.g., a wagering game such as poker) and the upper display device 18 of each of the gaming devices 10 displays a second type of game (e.g., a non-wagering game such as a bonus game).

In one embodiment, the gaming system enables the upper display device 18 of each of the gaming devices 10 to display the same game (e.g., a tournament game, a bonus or secondary game, or a primary game). In one such embodiment, the outcome of the second game is based, at least in part, on the outcome of the primary game. For example, the gaming system displays a primary game operable upon a variable wager (e.g., 1 to 200 credits) placed by a player of one of the gaming devices for each play of the primary game and a tournament game operable upon a static wager (e.g., 20 credits) placed by the player for each play of the tournament game. In this example, the player's tournament score or outcome is based on the combination of the primary game outcome and the tournament game outcome. That is, certain parameters of the primary game (e.g., the player's wager or the player's award) affect the player's tournament score or outcome. If a first player wagers more than a second player and both the first player and the second player obtain the same outcome in the primary game, the gaming system provides the first player with a higher tournament score or outcome because that player wagered more in the primary game than the second player. By basing the outcome or result of the second game (e.g., the tournament game) on a combination of the primary game and the second game, the gaming system provides the player an incentive to play both games.

In another embodiment, the award available in a first one of the games (e.g., the first game) is a monetary award while the award available in a second one of the games (e.g., the second game) is a non-monetary award. In this embodiment, the gaming system converts the monetary award into a non-monetary award which is combined with the non-monetary award from the second one of the games (e.g., the second game) to form a combined or modified non-monetary award based on both outcomes of the first and second games. For example, if the first game pays one or more awards in the form of credits and the second game is a bonus game which pays one or more awards in the form of points, the gaming system converts the amount of credits from the first game (e.g., a monetary award) into an amount of points (e.g., a non-monetary award) for the second game. In another such embodiment, the gaming system converts the non-monetary award into a monetary award which is combined with the monetary award from the first one of the games (e.g., the first game) to form a combined or modified monetary award based on both outcomes of the first and second games.

In another such embodiment, the bonus or secondary game includes a group gaming environment wherein the players at the gaming devices work in conjunction with one another to win one or more awards. In this embodiment, the gaming system reconfigures the function of at least one of the input devices to enable the players of the gaming devices to make one or more inputs associated with the group bonus game.

In one embodiment, the central display device 16 and/or the upper display device 18 display an advertisement or information relating to a sponsor or advertiser. In this embodiment, the gaming system provides the player with an incentive or advantage (e.g., an increased payback percentage, free spins, a multiplier or any other suitable incentive) for the primary game if that player keeps the displayed advertisement active. For example, the central display device displays a poker game and the upper display device displays an advertisement. In this example, the player moves the displayed advertisement to the central display device (and moves the primary game to the upper display device) to activate the incentive or advantage. Once the advertisement is activated, the gaming system provides the player with the incentive or advantage in the primary game for as long as the central display device and/or the upper display device displays the advertisement. In one embodiment, the sponsor or advertiser funds the incentive or advantage by paying a fee to the gaming establishment. In one embodiment, the fee is based on the number of advertisements displayed by the gaming system.

In one embodiment, the central display device and/or the upper display device displays an advertisement. In this embodiment, the gaming system provides an advantage or incentive to the player if the player maintains the advertisement on either the central display device or the upper display device for a designated period of time. For example, the gaming system displays an advertisement, and the player keeps the advantage or incentive, for as long as the player meets a designated threshold (e.g., a designated wager amount) in a designated period of time. In this example, if the player wagers fifty credits on the primary game within one minute, the gaming system continues to display the advertisement and provide the player with the advantage or incentive for another minute. In one embodiment, the gaming system displays a timer or clock to show the player when the advantage or incentive expires and a counter to show the player how many credits are needed to keep the advantage or incentive. It should be appreciated that by displaying advertising for third party companies (which may or may not have an affiliation with the gaming establishment) and enabling one or more players to interact with such advertising or offers (by reconfiguring one or more of the input devices), the gaming system provides such plays an opportunity to win additional awards (since the advertising operates simultaneously or substantially simultaneously with one or more primary games).

In one embodiment, the gaming device displays a game or advertisement on an overhead display and reconfigures at least one of the input devices to operate with the game or advertisement displayed by the overhead display. In different embodiments, the gaming system treats the overhead display device as the primary display device, as the secondary display device or as a third display device in addition to the primary and secondary display devices. For example, a bank or group of gaming devices are associated with an overhead display which is common to each of the gaming devices. In this example, after a triggering event, the gaming system causes the overhead display to display a game or advertisement. The gaming system reconfigures at least one input device for each of the gaming devices in the bank of devices to operate with the game or advertisement displayed by the overhead display. In this example, a group of players playing at the bank or group of gaming devices can simultaneously interact with a common game or advertisement displayed by the overhead display. In one embodiment, the group of players take turns playing the common game or advertisement displayed by the overhead display while also playing their individual primary games at their respective gaming devices.

In one embodiment, the gaming system enables the group of players to play or interact with the game or advertisement displayed by the overhead display. In one such embodiment, the group of players share any award, such as a progressive award, provided in association with the game displayed on the overhead display. In another such embodiment, the gaming system causes the secondary display device associated with the gaming device of each of the players in the group to display any potential awards which can be provided in the game displayed by the overhead display and/or any awards provided to the players from the game displayed by the overhead display.

In one embodiment, the gaming system displays a first game (such as a slot game) on a primary display device at a first point in time. In this embodiment, the first game is operable with both of a plurality of input devices and a touch screen. That is, at the first point in time when only a first game is displayed on the primary display device, the gaming system enables a player to make one or more inputs associated with the first game by utilizing either the touch screen or at least one other input device. In this embodiment, after a designated input device reconfiguration event occurs, the gaming system displays a second game (e.g., a bonus game) on a secondary display device at a second point in time. At this second point in time, the gaming system changes the functionality of the at least one other input device to enable a player to make one or more inputs associated with the second game. That is, at this second point in time when both the primary and secondary display devices display the first and second games, the gaming system enables a player to simultaneously make one or more inputs associated with: (i) the first game displayed on the primary display device utilizing the touch screen, (ii) the second game displayed on the secondary display device utilizing the at least one other input device, and (iii) vice versa.

In one embodiment, the central display device and the upper display device both display games simultaneously operable by a player. In one embodiment, the central display device and the upper display device both display primary games operable upon a wager placed by the player. At least one different input device is associated with each of the primary games so that the player can make separate inputs for both games simultaneously. In this embodiment, after an occurrence of a designated triggering event, the gaming system triggers a bonus game that is associated with a progressive award. For example, if the designated triggering event occurs in association with the primary game displayed by the upper display device, the upper display devices displays the bonus game associated with the progressive award. In this embodiment, the gaming system enables the player to simultaneously make separate inputs for the primary game displayed on the central display device and the bonus game displayed on the upper display device.

In one embodiment, the designated triggering event is based on a comparison of the game play displayed by the central display device relative to the game play displayed by the upper display device. For example, in one embodiment, the gaming system tracks the amount of money or credits wagered by the player for the game displayed by the central display device and tracks the amount of money or credits wagered by the player for the game displayed by the upper display device. In this embodiment, the gaming system compares the tracked amounts and determines whether a ratio between the tracked amounts meets or exceeds a designated threshold. In this embodiment, if the ratio between the tracked amounts meets or exceeds the designated threshold, the bonus triggering event occurs and the central display device or the upper display device displays the bonus game. In one embodiment, the gaming system reconfigures at least one of the input devices so that the player can make inputs for the bonus game using the reconfigured input device(s) while simultaneously enabling the player to make one or more inputs for the primary game. In one embodiment, the gaming system displays a message or other information via one or more service windows to explain the reconfigured input device(s). In another embodiment, the gaming system enables the player to choose which input devices to reconfigure and the respective functions of such input devices via one or more service windows.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
a cabinet;
a plurality of display devices supported by the cabinet, the plurality of display devices including a first display device and a second display device;
a plurality of input devices supported by the cabinet, the plurality of input devices including a first input device and a second input device;
a first processor supported by the cabinet;
a first memory device which stores a first plurality of instructions, which when executed by the first processor, cause the first processor to operate with the first display device to:
(a) cause the first display device to display a first game upon a wager placed by a player,
(b) prior to an occurrence of a designated input device reconfiguration event, enable the player to make a first input in association with the first game using each of the first input device and the second input device,
(c) after the occurrence of the designated input device reconfiguration event, enable the player to make the first input in association with the first game using the first input device, and
(d) cause any award resulting from the first game to be provided to the player;
a second processor remote from the cabinet; and
a second memory device which stores a second plurality of instructions, which when executed by the second processor after the occurrence of the designated input device reconfiguration event, cause the second processor to operate with the second display device to:
(a) cause the second display device to display a second game,
(b) simultaneous with enabling the player to make the first input in association with the first game using the first input device, enable the player to make a second input in association with the second game using the second input device, and
(c) cause any award resulting from the second game to be provided to the player.

2. The gaming system of claim 1, wherein the first input device is associated with a touch screen.

3. The gaming system of claim 1, wherein when executed by the first processor, the first plurality of instructions cause the first processor, for each of a plurality of points in time after the occurrence of the designated input device reconfiguration event, to enable the player to make the first input in association with the first game using the first input device.

4. The gaming system of claim 3, wherein when executed by the second processor, the second plurality of instructions cause the second processor, for each of the plurality of points in time after the occurrence of the designated input device reconfiguration event, simultaneous with enabling the player to make the first input in association with the first game using the first input device, to enable the player to make the second input in association with the second game using the second input device.

5. The gaming system of claim 1, wherein the first and second processors cause the first one of the display devices and the second one of the display devices to display the first and second games substantially simultaneously.

6. The gaming system of claim 1, wherein the first game is a primary game and the second game is a bonus game.

7. The gaming system of claim 1, wherein the first game is a first primary game operable upon a first wager and the second game is a second primary game operable upon a second wager.

8. The gaming system of claim 1, wherein the second game is a tournament game.

9. The gaming system of claim 8, wherein the first game is associated with an outcome and the tournament game is associated with a tournament outcome, the tournament outcome being based, at least in part, on the outcome of the first game.

10. The gaming system of claim 9, wherein the tournament game is operable upon a tournament wager placed by the player.

11. The gaming system of claim 9, wherein the tournament game is operable without an additional wager placed by the player.

12. The gaming system of claim 1, wherein when executed by the first processor, the first plurality of instructions cause the first processor, after an occurrence of a designated display device reconfiguration event, to cause the second display device to display the first game.

13. The gaming system of claim 12, wherein when executed by the second processor, the second plurality of instructions cause the second processor, after the occurrence of the designated display device reconfiguration event, to cause the first display device to display the second game.

14. The gaming system of claim 13, wherein the designated display device reconfiguration event occurs if the player makes a designated input using at least one of the input devices.

15. The gaming system of claim 14, wherein the plurality of input devices includes a designated input device, the designated input device being configured to receive the designated input from the player.

16. A gaming system comprising:
a plurality of input devices, the plurality of input devices including a first input device and a second, different input device;
a first processor;
a first memory device which stores a first plurality of instructions, which when executed by the first processor, cause the first processor to:
(i) operate with the first input device and the second, different input device, at a first point in time, to enable a player to make a first input in association with a first game using either the first input device or the second, different input device, and
(ii) operate with the first input device, at a second point in time, to enable the player to make the first input in association with the first game using the first input device;
a second processor; and
a second memory device which stores a second plurality of instructions, which when executed by the second processor, cause the second processor to operate with the second, different input device, independent of the first processor, at the second point in time, to enable the player to make a second input in association with a second game using the second, different input device.

17. The gaming system of claim 16, wherein the first and second games are displayed substantially simultaneously.

18. The gaming system of claim 16, wherein the first game is a primary game and the second game is a bonus game.

19. The gaming system of claim 16, wherein the first game is a first primary game operable upon a first wager and the second game is a second primary game operable upon a second wager.

20. The gaming system of claim 16, wherein the second game includes a tournament game.

21. The gaming system of claim 20, wherein the first game is associated with an outcome and the tournament game is associated with a tournament outcome, the tournament outcome being based, at least in part, on the outcome of the first game.

22. The gaming system of claim 21, wherein the tournament game is operable upon a tournament wager placed by the player.

23. The gaming system of claim 21, wherein the tournament game is operable without an additional wager placed by the player.

24. A gaming system comprising:
a gaming machine including:
a cabinet;
at least one gaming machine processor;
a plurality of input devices supported by the cabinet, the plurality of input devices including a first input device and a second, different input device;
a plurality of display devices supported by the cabinet, the plurality of display devices including a first display device and a second display device; and
at least one memory device which stores a plurality of instructions, which when executed by the at least one gaming machine processor, cause the at least one gaming machine processor to:
(a) prior to an occurrence of a designated display device reconfiguration event, cause the first display device to display a first game upon a wager placed by a player,
(b) after the occurrence of the designated display device reconfiguration event, cause the second display device to display the first game, and
(c) cause any award resulting from the first game to be provided to the player, and
at least one central controller configured to operate with the gaming machine to:
(a) after the occurrence of the designated display device reconfiguration event, cause the first display device to display a second game, and
(b) cause any award resulting from the second game to be provided to the player.

25. The gaming system of claim 24, wherein when executed by the at least one gaming machine processor, the plurality of instructions cause the at least one gaming machine processor, prior to the occurrence of the designated display device reconfiguration event, to enable the player to make a first input in association with the first game using the first input device.

26. The gaming system of claim 25, wherein the at least one central controller is programmed to operate with the gaming machine, prior to the occurrence of the designated display device reconfiguration event, to: (a) cause the second display device to display the second game, and (b) enable the player to make a second input in association with the second game using the second input device.

27. The gaming system of claim 26, wherein when executed by the at least one gaming machine processor, the plurality of instructions cause the at least one gaming machine processor, after the occurrence of the designated display device reconfiguration event, to enable the player to make the first input in association with the first game using the second input device.

28. The gaming system of claim 27, wherein the at least one central controller is programmed to operate with the gaming machine, after the occurrence of the designated display device reconfiguration event, to enable the player to make the second input in association with the second game using the first input device.

29. The gaming system of claim 28, wherein the first input device is associated with a touch screen.

30. The gaming system of claim 24, wherein the first game is a first primary game operable upon the wager and the second game is a second primary game operable upon a second wager.

31. The gaming system of claim 24, wherein the at least one central controller is programmed to operate with the gaming machine to cause the designated display device reconfiguration event to occur if the player makes a designated input using at least one of the input devices.

32. The gaming system of claim 24, wherein the first game is a primary game and the second game is a tournament game.
